(19) United States
(12) Patent Application Publication
(10) Pub. No.: US 2009/0300008 A1
(43) Pub. Date: Dec. 3, 2009

(54) ADAPTIVE RECOMMENDER TECHNOLOGY

(75) Inventors: Rick Hangartner, Corvallis, OR (US); James Shur, Corvallis, OR (US)

Correspondence Address: Stolowitz Ford Cowger LLP, 621 SW Morrison St, Suite 600, Portland, OR, 97205, US

(73) Assignee: Strands, Inc., Corvallis, OR (US)

(21) Appl. No.: 12/475,220

(22) Filed: May 29, 2009

Related U.S. Application Data
(60) Provisional application No. 61/057,833, filed on May 31, 2008.

(51) Int. Cl. G06F 17/30

(52) U.S. Cl. 707/5; 707/E17.108; 707/102; 707/E17.044; 707/3

(57) ABSTRACT

A computer implemented method for incorporating media item data for use in a media item recommender system comprising: accessing a first database comprising a plurality of media item identifiers and associated metadata corresponding to each of a plurality of media items identified by the media item identifiers; generating first correlation data based on a comparison of the metadata corresponding to pairs of the media item identifiers to detect similarities between the media items identified; accessing a second database comprising a plurality of media item identifier sets for identifying sets of media items; generating second correlation data based on an analysis of the media item identifier sets to determine incidence of selected subsets of media item identifiers occurring together in a same media item identifier set; accessing a third database comprising a plurality of consumed media item identifier sets, wherein the consumed media item identifier sets associate one or more media item identifiers in a particular set based on media item consumption data; generating third correlation data based on an analysis of the consumed media item identifier sets to determine incidence of selected subsets of the consumed media item identifiers occurring together in a same consumed media item identifier set; and merging the first, second, and third correlation data to generate media item recommender data.

### RELATED APPLICATIONS

This application claims priority to U.S. Provisional Application No. 61/057,833 filed May 31, 2008 and incorporated herein by this reference in its entirety.

### COPYRIGHT NOTICE

© 2002-2009 Mystrands, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

This invention pertains to methods and systems to provide recommendations of media items, for example music items, in which the recommendations reflect dynamic adaptation in response to explicit and implicit user feedback.

### BACKGROUND

New technologies combining digital media item players with dedicated software, together with new media distribution channels through computer networks (e.g., the Internet) are quickly changing the way people organize and play media items. As a direct consequence of such evolution in the media industry, users are faced with a huge volume of available choices that clearly overwhelm them when choosing what item to play in a certain moment.

This overwhelming effect is apparent in the music arena, where people are faced with the problem of selecting music from very large collections of songs. However, in the future, we might detect similar effects in other domains such as music videos, movies, news items, etc.

### TECHNOLOGY SUMMARY

In general, the disclosed process and device is applicable to any kind of media item that can be grouped by users to define mediasets. For example, in the music domain, these mediasets are called playlists. Users put songs together in playlists to overcome the problem of being overwhelmed when choosing a song from a large collection, or just to enjoy a set of songs in particular situations. For example, one might be interested in having a playlist for running, another for cooking, etc.

Different approaches can be adopted to help users choose the right options with personalized recommendations. One kind of approach employs human expertise to classify the media items and then use these classifications to infer recommendations to users based on an input mediaset. For instance, if in the input mediaset the item x appears and x belongs to the same classification as y, then a system could recommend item y based on the fact that both items are classified in a similar cluster. However, this approach requires an incredibly huge amount of human work and expertise. Another approach is to analyze the data of the items (audio signal for songs, video signal for video, etc) and then try to match user's preferences with the extracted analysis. This class of approaches is yet to be shown effective from a technical point of view.

The use of a large number of playlists to make recommendations may be employed in a recommendation scheme. Analysis of “co-occurrences” of media items on multiple playlists may be used to infer some association of those items in the minds of the users whose playlists are included in the raw data set. Recommendations are made, starting from one or more input media items, based on identifying other items that have a relatively strong association with the input item based on co-occurrence metrics. More detail is provided in our PCT publication number WO 2006/084102.

Recommendations based on playlists or similar lists of media items are limited in their utility for generating recommendations because the underlying data is fixed. While new playlists may be added (or others deleted) from time to time, and the recommendation databases updated, that approach does not directly respond to user input or feedback. Put another way, users may create playlists, and submit them (for example through a web site), but the user may not in fact actually play the items on that list. User behavior is an important ingredient in making useful recommendations. One aspect of this disclosure teaches how to take into account both what a user “says” (by their playlist) and what the user actually does, in terms of the music they play, or other media items they experience. The present application discloses these concepts and other improvements in related recommender technologies.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a block diagram illustrating an embodiment of an adaptive recommender system.

FIG. 2 is a block diagram illustrating a process pipeline for an embodiment of a Pre-computed Correlation (PCC) builder in an adaptive recommender system.

FIG. 3 illustrates a weighted graph representation for the associations within a collection of media items represented as nodes in the graph. Each edge between two media items comprises a weighted metric for the co-occurrence estimation data.

FIG. 4 illustrates a weighted graph representation for the associations within a collection of media items represented as nodes in the graph resulting from a graph search of a graph representing co-occurrence data.

FIG. 5 is a block diagram illustrating a process for extracting playstreams from played media events.

FIG. 6 and FIG. 7 present a specification of the playstream and playlist CTL events.

FIG. 8 is a block diagram illustrating an embodiment of a playstream extraction process.

FIG. 9 is a block diagram illustrating an embodiment of a playstream-to-playlist converter process 900.

### DETAILED DESCRIPTION

Reference is now made to the figures in which like reference numerals refer to like elements. For clarity, the first digit of a reference numeral indicates the figure number in which the corresponding element is first used.

In the following description, certain specific details of programming, software modules, user selections, network transactions, database queries, database structures, etc. are omitted to avoid obscuring the invention. Those of ordinary skill in computer sciences will comprehend many ways to implement the invention in various embodiments, the details of which can be determined using known technologies.

Furthermore, the described features, structures, or characteristics may be combined in any suitable manner in one or more embodiments. In general, the methodologies of the present invention are advantageously carried out using one or more digital processors, for example the types of microprocessors that are commonly found in servers, PC's, laptops, PDA's and all manner of desktop or portable electronic appliances.

### System Overview

Described herein is a new system for building Pre-Computed Correlation (PCC) datasets for recommending media items. In some embodiments, the proposed system combines the methods to build mutually exclusive PCC datasets into a single unified process. The process is presented here as a simple discrete dynamical system that combines item similarity estimates derived from statistical data about user media consumption patterns with a priori similarity estimates derived from metadata to introduce new information into the PCC datasets. Statistical data gathered from user interactions with recommender-driven media experiences is then used as feedback to fine-tune these PCC datasets.

In one embodiment, the process takes advantage of statistical data gathered from user-initiated media consumption and metadata to introduce new information into PCCs in a way that leverages social knowledge and addresses a “cold-start” problem. The “cold-start problem” arises when there are new media items that are not yet included in any user-defined associations such as playlists or playstreams. The problem is how to make recommendations without any such user-defined associations. The system disclosed herein incorporates metadata related to new media items with the user-defined associations to make recommendations related to the new media items until the new media items begin to appear in user-defined associations or until passage of a particular time period.

In one embodiment, the PCCs are fine-tuned using feedback in the form of user interactions logged from recommender-driven media experiences. In some embodiments, the system may be used to build individual PCC datasets for specific media catalogs, a single PCC dataset for multiple catalogs, or other special PCC datasets (new releases, community-based, etc.).

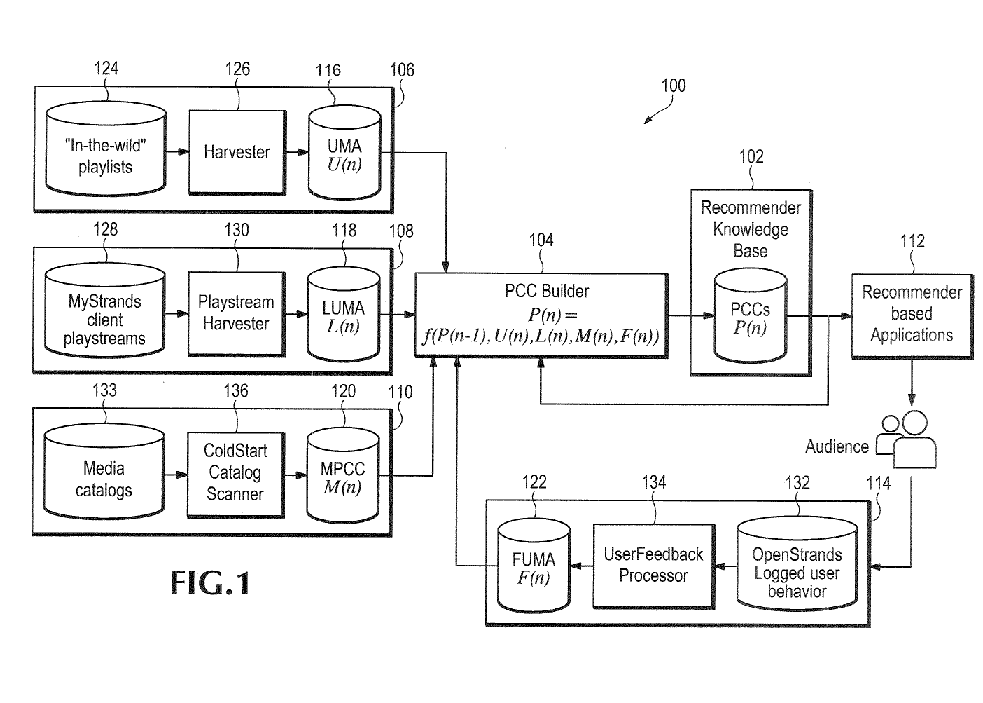

FIG. 1 illustrates an embodiment of an adaptive recommender system 100 for recommending media items comprising: a recommender module 102, PCC builder module 104, playlist analyzer 106, playstream analyzer 108, media catalog analyzer 110, user feedback analyzer 114, and recommender application 112. Adaptive recommender system 100 is a discrete dynamical system for recommending media items. In one embodiment, adaptive recommender system 100 analyzes relational information from a variety of media and media related sources to generate one or more datasets for approximating user media item preferences based on the relational information.

In an embodiment, the playlist analyzer 106 accesses and analyzes playlists from “in-the-wild,” aggregating the playlist data in an Ultimate Matrix of Associations (UMA) dataset 116. “In-the wild” playlists are those accessed from various databases and publicly and/or commercially available playlist sources. The playstream analyzer 108 accesses and analyzes consumed media item data (e.g., logged user playstream data) aggregating the consumed media item data in a Listening Ultimate Matrix of Associations (LUMA) dataset 118. The media catalog analyzer 110 accesses and analyzes media catalog data aggregating the media item data in an Metadata PCC (MPCC) dataset 120. The user feedback analyzer 114 accesses and analyzes logged user feedback responsive to recommended media items aggregating the data in a Feedback Ultimate Matrix of Associations (FUMA) dataset 122.

In one embodiment, PCC builder module 104 merges the UMA 116, LUMA 118, FUMA 122 and MPCC 120 relational information to generate a single media item recommender dataset to be used in recommender application 112 configured to provide users with media item recommendations based on the recommender dataset.

In one embodiment, the playlist analyzer 106 may generate the UMA dataset 116 by accessing “in-the-wild” playlists source(s) 124. Similarly, the playstream analyzer 108 may generate the LUMA dataset 118 by accessing a playstream data (ds) database 128 which comprises at least one play stream source. The playstream harvester 130 compiles statistics on the co-occurrences of media items in the playstreams aggregating them in the LUMA dataset 118. LUMA dataset 118 can also be viewed as an adjacency matrix of a weighted, directed graph. In one embodiment, each row Lᵢ in the graph is a vector of statistics on the co-occurrences of item i with every other item j in the collection of playstreams gathered by the playstream harvester 130, and, as with the UMA dataset 116, is therefore the weight on the edge in the graph from item i to item j. Generating the LUMA dataset 118 and playstream data by analyzing consumed media item data is discussed in greater detail below.

In one embodiment, the media catalog analyzer 110 generates the MPCC dataset 120 by accessing the media catalog(s) 133. The coldstart catalog scanner 136 compares the metadata for media items in one or more media catalogs 133. The all-to-all comparison of media item metadata by coldstart catalog scanner 136 generates a preliminary PCC, M(n), that can be combine with a preliminary PCC corresponding to the LUMA dataset 118 and UMA dataset 116 generated in PCC builder 104.

In one embodiment, the user feedback analyzer 114 generates the FUMA dataset 122 by aggregating user feedback statistics with popularity and similarity statistics based on the LUMA dataset 118. The user generated feedback is responsive to media item experiences associated with media item recommendations driven by the recommender 102. However, there are various other methods of incorporating user generated feedback and claimed subject matter is not limited to this embodiment. Generating the FUMA dataset 122 using the user feedback, popularity and similarity statistics is described is greater detail below.

In one embodiment, the PCC builder initially accesses or receives the relational data UMA dataset 116, (U(n)), LUMA dataset 118, (L(n)), and the MPCC dataset 120, (M(n)). At each PCC update instant n, this relational information is combined with FUMA dataset 122, (F(n)), and the previous value P(n−1) to compute the new PCC values 138 (P(n)) for item i. The computed PCCs 138 are supplied to the recommender 102, and the recommender knowledge base (kb) 102 is used to drive recommender-based applications 112. In one embodiment, the user responses to those applications are logged at user behavior log 132, between instant n−1 and n. User feedback processor 134 processes the logged user feedback to generate the FUMA dataset 122 (F(n)) used by the PCC Builder 104 in the update operation, here represented formally as:

P(n)=f(P(n−1),U(n),L(n),M(n),F(n))

In some embodiments, individual values in the MPCC dataset 120 (M(n)) may not evolve after initial computation, the time evolution in M(n) involves the affect of adding new media items or metatags to the media catalogs 133 (mᵢ and mᵢⱼ). The adaptive recommender system 100 proposes a method for combining the U(n) and L(n) into new values to which a graph search process is applied and a method for modify the result using the M(n) and F(n).

### Overview of PCC Datasets, Modeling, and Estimation Techniques

In some embodiments, Pre-Computed Correlation (PCC) datasets are built from various Ultimate Matrix of Association (UMA) and Listening UMA datasets based on playlist and/or playstream data. The UMA and LUMA datasets are discussed in greater detail below.

In some embodiments, the PCCs may be built using ad hoc methods. For instance, the PCCs may be built from processed versions of UMA and LUMA datasets wherein the UMA or LUMA datasets for the item with ID i may include two random variables qᵢ and c_{i,j}, which may be treated as measurements of the popularity of item i and the similarity between items i and j.

Using one such ad hoc method, the similarities may be first weighted as:

c̅_{i,j}=c_{i,j}[2 ln q/(qᵢqⱼ)^{k}]

### Where:

q=total number of playlists
k=arbitrary weighting factor

The weighted similarities c̅ may then be normalized as:

$${\overline{c}}_{i , j} = {\overline{c}}_{i , j} / {\sum }_{j \neq i} {\overline{c}}_{i , j}$$

In this embodiment, the PCC for item i is built by searching the graph starting with item j in the graph and ordering all items j≠i according to their maximum transitive similarity r_{i,j} to item i. The transitive similarity along a path e_{i,j}={i=k₀, k₁, k₂, . . . , j=kₙ} from i to j along which no item kₘ appears twice is computed as:

r(e_{i,j})=Πₗ₌₀^{l=n-1}cₖ_{_{l,}}ₖ_{ₗ₊₁}

The maximum transitive similarity between items i and j then is computed, subject to search depth and time bounding constraints, as:

r_{i,j}=maxₑ_{_{i,j}}{r(e_{i,j})}

In other embodiments, PCCs may be built using a principled approach, such as for instance using a Bernoulli model to build PCC datasets from UMA and/or LUMA datasets as described below.

### Bernoulli Model for Co-Occurrences

The simplest model for the co-occurrence of two items i and j on a playlist or in a playstream is a Bernoulli model that places no deterministic or probabilistic constraints on playstream/playlist length. This Bernoulli model just assumes that:

ρᵢⱼ=Pr{Oc(j)|Oc(i)}=Pr{Oc(i)|Oc(j)}=ρⱼᵢ

where Oc(i) denotes item i occurs on a playlist or in a playstream, and 0≦ρᵢⱼ≦1 is some symmetric measure of the “similarity” of item i and j. The random occurrence of both items on a playlist or in a playstream given that either item occurs then is modeled as a Bernoulli trial with probability:

$$\begin{matrix}Pr \{ Oc ( i ) Oc ( j ) \vert Oc ( i ) Oc ( j ) \} = \frac{Pr \{ \begin{matrix}Oc ( j ) Oc ( j ) , \\ Oc ( i ) Oc ( j )\end{matrix} \}}{Pr \{ Oc ( i ) Oc ( j ) \}} \\ = \frac{Pr \{ \begin{matrix}Oc ( i ) Oc ( j ) , \\ Oc ( i ) Oc ( j )\end{matrix} \}}{\begin{matrix}Pr \{ Oc ( i ) \} + Pr \{ Oc ( j ) \} - \\ Pr \{ Oc ( i ) Oc ( j ) \}\end{matrix}}\end{matrix}$$

Taking advantage of the identities:

$$\begin{matrix}Pr \{ Oc ( i ) Oc ( j ) \} = Pr \{ Oc ( i ) Oc ( j ) , Oc ( i ) \} \\ = Pr \{ Oc Oc ( j ) , Oc ( j ) \} \\ = Pr \{ Oc ( i ) Oc ( j ) , Oc ( i ) Oc ( j ) \}\end{matrix}$$

this can be re-expressed as:

$$Pr \{ Oc ( i ) Oc ( j ) , Oc ( i ) Oc ( j ) \} = Pr \{ Oc ( i ) Oc ( j ) , Oc ( i ) \} Pr \{ Oc ( i ) Oc ( j ) , Oc ( j ) \} / [ \begin{matrix}Pr \{ Oc ( i ) Oc ( j ) , Oc ( j ) \} Pr \{ Oc ( i ) \} + \\ Pr \{ ( Oc ( i ) Oc ( j ) , Oc ( i ) \} Pr \{ Oc ( j ) \} - \\ Pr \{ Oc ( i ) Oc ( j ) , Oc ( i ) \} Pr \{ Oc ( i ) Oc ( j ) , Oc ( j ) \}\end{matrix} ] = Pr \{ Oc ( i ) Oc ( j ) \vert Oc ( i ) \} Pr \{ Oc ( i ) Oc ( j ) \vert Oc ( j ) \} / [ \begin{matrix}\begin{matrix}Pr \{ Oc ( i ) Oc ( j ) \vert Oc ( j ) \} + \\ Pr \{ Oc ( i ) Oc ( j ) \vert Oc ( i ) \} -\end{matrix} \\ Pr \{ Oc ( i ) Oc ( j ) \vert Oc ( i ) \} \\ Pr \{ Oc ( i ) Oc ( j ) \vert Oc ( j ) \}\end{matrix} ]$$

Finally, denoting ηᵢⱼ=Pr{Oc(i)ΛOc(j)|Oc(i)V Oc(j)}

$${η}_{ij} = \frac{{ρ}_{ij} {ρ}_{ji}}{{ρ}_{ij} + {ρ}_{ji} - {ρ}_{ij } {ρ}_{ji}} = \frac{{ρ}_{ij}}{2 - {ρ}_{ij}}$$

$$or$$

$${ρ}_{ij} = \frac{2 {η}_{ij}}{1 + {η}_{ij}}$$

To model the co-occurrences, let cᵢ(n) denote the number of actual playlists/playstreams that include item i up through update index n, and let c_{i,j}(n) denote the actual number of playlists/playstreams that includes both item i and item j. To capture initial conditions correctly, assume also there is some earliest update n₀>0 after which both items could be included on a playlist/playstream. The total number of playlists including item i or item j then is

c(i,j;n)=[cᵢ(n)−cᵢ(n₀)]+[cⱼ(n)−cⱼ(n₀)]−cᵢⱼ(n)

Since the occurrence of both items on a playlist or in a playstream given that either item occurs is modeled as a Bernoulli trial, the number of playlists/playstreams that includes item j given that the playlist/playstream includes item i after update no is a binomial random variable cᵢⱼ(n) with distribution:

$${f}_{c} ( c ) = ( \begin{matrix}c ( i , j ; n ) \\ c\end{matrix} ) {{η}^{c} ( 1 - η )}^{c ( i , j ; n ) - c}$$

and mean and variance:

μ_{c}=c(i,j;n)η σ_{c}²=c(i,j;n)η(1−η)

respectively.

### Maximum Likelihood Similarity Estimate

Continuing with the general Bernoulli model for building PCCs, one quantity of interest of this model of co-occurrences is the estimate \hat{ρ}ᵢⱼ of the similarity ρᵢⱼ given the quantities cᵢ(n), cⱼ(n), and cᵢⱼ(n). For the binomial distribution f_{c}(c), the maximum-likelihood estimate \hat{η} for η is the value which maximizes the function f_{c}(c) for a given c=cᵢⱼ(n) and c(i, j, n). This is the value \hat{η} such that

$$\frac{\partial f}{\partial η} ( \hat{η} ) = 0 = ( \begin{matrix}c ( i , j ; n ) \\ c\end{matrix} ) [ \begin{matrix}c {{\hat{η}}^{c - 1} ( 1 - \hat{η} )}^{c ( i , j ; n ) - c} - \\ {\hat{η}}^{c} ( c ( i , j ; n ) - c ) {( 1 - \hat{η} )}^{c ( i , j ; n ) - c - 1}\end{matrix} ]$$

From which it is easily computed that:

$$\hat{η} - \frac{{c}_{ij} ( n )}{c ( i , j ; n )}$$

The maximum likelihood estimate for the similarity then is (perhaps not surprisingly)

$${\hat{ρ}}_{ij} = \frac{2 η }{1 + η} = \frac{2 {c}_{ij} ( n )}{c ( i , j ; n ) + {c}_{ij} ( n )} = \frac{2 {c}_{ij} ( n )}{[ {c}_{i} ( n ) - {c}_{i} ( {n}_{0} ) ] - [ {c}_{j} ( n ) - {c}_{j} ( {n}_{0} ) ]}$$

### Expected Number of Co-Occurrences

Continuing still with the general Bernoulli model for building PCCs, another quantity of interest is the expected number of co-occurrences of two items given that either of them appears on a playlist or in a playstream. This is the quantity:

$$E \{ {c}_{ij} ( n ) \vert c ( i , j ; n ) \} = {μ}_{c} = c ( i , j ; n ) η = c ( i , j ; n ) \frac{{ρ}_{ij}}{2 - {ρ}_{ij}}$$

where c(i, j; n) is the number of playlists or playstreams that include either item i or j.

As already noted, given actual values cᵢ(n), cⱼ(n), cᵢⱼ(n), and n₀, the number of playlists or playstreams including item i or j item is:

c(i,j;n)=[cᵢ(n)−cᵢ(n₀)]+[cⱼ(n)−cⱼ(n₀)]−cᵢⱼ(n)

If ρᵢⱼ is known, the expected number of co-occurrences, to which cᵢⱼ(n) can be compared, would be

$$E \{ c ( n ) \vert c ( i , j ; n \} = \{ [ {c}_{i} ( n ) - {c}_{i} ( {n}_{0} ) ] + [ {c}_{j} ( n ) - {c}_{j} ( {n}_{0} ) ] - {c}_{ij} ( n ) \} \frac{{ρ}_{ij}}{2 - {ρ}_{ij}}$$

The probability that cᵢⱼ(n) would actually be observed is:

$${f}_{c} ( {c}_{ij} ( n ) ) = ( \begin{matrix}c ( i , j ; n ) \\ {c}_{ij} ( n )\end{matrix} ) {( \frac{{ρ}_{ij}}{2 - {ρ}_{ij}} )}^{{c}_{ij} ( n )} {( 1 - \frac{{ρ}_{ij }}{2 - {ρ}_{ij}} )}^{c ( i , j ; n ) - {c}_{ij} ( n )}$$

### Minimum Variance Linear Estimation

Given multiple random processes x₁, . . . , xₘ representing independent samples xᵢ=x+wᵢ of an underlying variable x corrupted by zero-mean additive measurement noise wᵢ, a linear estimate \hat{x} for x is:

\hat{x}=k₁x₁+ . . . +kₘxₘ

In the optimal minimum variance estimator, the gains k₁, . . . , kₘ are chosen such that the estimation error:

\hat{x}=x−x=x−(k₁x₁+ . . . +kₘxₘ)

has zero mean E{\tilde{x}} and minimum variance E{\tilde{x}²}, given the known variances σ₁², . . . σ_{□}² of the m observations for x.

The zero mean requirement is met by:

$$0 = E \{ \tilde{x} \} = E \{ x - ( {k}_{1} {x}_{1} + … + {k}_{m} {x}_{m} ) \} = x - x {\sum }_{j = 1}^{m} {k}_{j}$$

From this, the constraint kₘ=1−Σᵢ₌₁^{m-1}kᵢ results.

The variance of the \tilde{x} can be simplified from the properties that E{wᵢ}=0, E{wᵢwᵢ}=σ₁², and E{wᵢwᵢ}=0 for i≠j.

$$E \{ {\tilde{x}}^{2} \} = E \{ {( x - \tilde{x} )}^{2} \} = E \{ {[ ( x - x {\sum }_{j = 1}^{m} {k}_{j} ) - {\sum }_{j = 1}^{m} {k}_{j} {w}_{j} ]}^{2} \} = {\sum }_{j = 1}^{m} {k}_{j}^{2} {σ}_{j}^{2}$$

Noting the relationship on the kᵢ derived from the zero-mean constraint, this simplifies further to

$$E \{ {\tilde{x}}^{2} \} = {\sum }_{j - 1}^{m - 1} {k}_{j}^{2} {σ}_{j}^{2} - {( 1 - {{\sum }_{j - 1}}^{m - 1} {k}_{j} )}^{2} {σ}_{m}^{2}$$

The minimum-variance choices for the gains kᵢ is found by solving the family of simultaneous equations:

$$0 = \partial E \{ {\tilde{x}}^{2} \} / \partial {k}_{i} = 2 {k}_{i} {σ}_{i}^{2} + 2 ( {\sum }_{j = 1}^{m - 1} {k}_{j} - 1 ) {σ}_{m}^{2}$$

for i=1, . . . , m−1. The general solution is:

$${k}_{i} = \frac{1}{{σ}_{i}^{2} {\sum }_{j = 1}^{m} ( 1 / {σ}_{j}^{2} )}$$

while for the special case m=2

$${k}_{1} = \frac{{σ}_{2}^{2}}{{σ}_{1}^{2} + {σ}_{2}^{2}}$$

$${k}_{2} = \frac{{σ}_{1}^{2}}{{σ}_{1}^{2} + {σ}_{2}^{2}}$$

### Media Catalog Analyzer—Output MPCC

Referring again to FIG. 1, in an embodiment, media catalog analyzer 110 comprises a process for using comparisons mᵢⱼ and mⱼᵢ of the metadata for two items i and j as prior information for the computation of pᵢⱼ and pⱼᵢ in the PCC datasets. In this way, metadata similarities can be used to generate MPCCs 120 (M(n)) to cold-start recommendations for items, and recommendations from items, before playlist or playstream data is available.

In one embodiment, Mᵢ datasets for new items i are initially computed and updated each processing instant, by the following general process:
1. When item i is introduced in the catalog, a heuristic process may be used to compute a dataset Mᵢ consisting of metadata comparisons mᵢⱼ for the K most similar items. Similarly, mⱼᵢ=mᵢⱼ is inserted into the Mⱼ for all mᵢⱼ in Mᵢ.
2. When building the dataset Zᵢ(n) for item i, if the graph search process encounters an item j for which there is no Mⱼ or mᵢⱼ in Mᵢ, Mᵢ and Mⱼ without any co-occurrences are built if necessary, and/or mᵢⱼ may be added to Mᵢ and mⱼᵢ may be added to Mⱼ

This process assumes that a suitable computation of the similarity mᵢⱼ of two items i and j is available. Additionally, the process accounts for the case in which the catalog of seed items for recommendations contains items that are not in, or are even completely disjoint from, the catalog of recommendable items.

### Playlist Analyzer—Output UMA

Playlist analyzer 106 generates the UMA dataset 116 by accessing “in-the-wild” playlists source(s) 124. Harvester 126 compiles statistics on the co-occurrences of media items in the playlists such as tracks, artists, albums, videos, actors, authors and/or books. These statistics are aggregated in the UMA dataset 116. UMA dataset 116 can be viewed as an adjacency matrix of a weighted, directed graph. In one embodiment, each row Uᵢ in the graph is a vector of statistics on the co-occurrences of item i with every other item j in the collection of playlists gathered by the Harvester 126 process, and therefore is the weight on the edge in the graph from item i to item j.

### Playstream Analyzer—Output LUMA

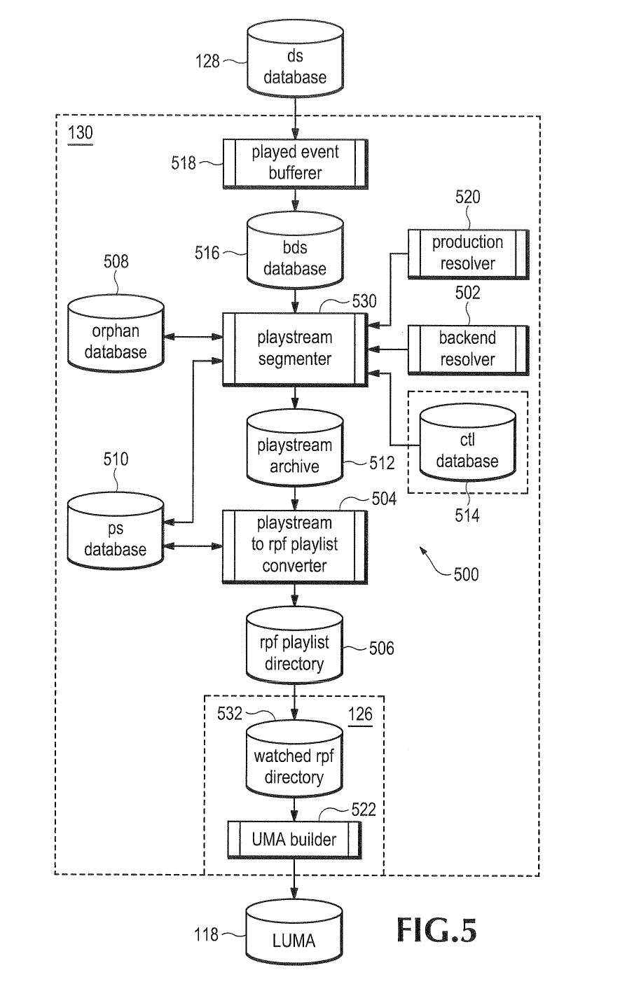

FIG. 5 presents a dataflow diagram of an embodiment of a Listening UMA (LUMA) 118 build process 500 performed in Playstream analyzer 108 (as shown in FIG. 1). Here, LUMA 118 is built from played media events stored in a played table of the ds database 128 in a manner analogous to that of how UMA 116 is built from playlists. For each user, sets of related played events are segmented into playstreams and the playstreams are then edited and translated into Raw Playlist Format (rpf) playlists by playstream to rpf playlist converter 504 and stored in playlist directory 506. Finally, these rpf playlists may be fed into an instance of the UMA builder 106 to produce LUMA 118. In one embodiment, the playstream extraction, segmentation, conversion and storage processes or “harvesting” take place in playstream harvester 130 (shown in FIG. 1).

### Data Stores

The dataflow diagram of FIG. 5 illustrates that there are a number of data stores associated with the LUMA build process. The source data databases ds database 128 and orphan database 508, the playstream segmentation process (ps) database 510 which includes the state data for the segmentation process, and the playstreams disk archive 512 which houses the extracted playstreams as individual files analogous to playlists. In some embodiments, the system event logging (ctl) database 514 may be used in the segmentation process. The format and contents of each of these data stores are described below.

### Source Databases

In one embodiment, the played events in the played table ds database 128 is the primary source data for LUMA 118. The data is buffered in the played event buffer 518 and stored in the Buffered Playlist Data (bds) database 516. Table 1 below presents a column structure of the played table. Several columns of the “played” table are relevant for building LUMA 118.

TABLE 1

| Field | Type | Null | Key | Default |
|---|---|---|---|---|
| pd_played_id_pk | int(11) | NO | PRI | 0 |
| pd_user_id_pk_fk | int(11) | NO | MUL | 0 |
| pd_remote_addr | varchar(255) | NO | | |
| pd_break | tinyint(1) | YES | | 0 |
| pd_shuffle | tinyint(1) | YES | | 0 |
| pd_track_title | varchar(255) | NO | | |
| pd_artist_d | varchar(255) | NO | | |
| pd_album_d | varchar(255) | NO | | |
| pd_track_id | int(11) | YES | MUL | |
| pd_orphan_id | int(11) | YES | | |
| pd_playlist_name | varchar(255) | YES | | |
| pd_begin_time | timestamp | YES | MUL | CURRENT_TIMESTAMP |
| pd_end_time | timestamp | YES | MUL | 0000-00-00 00:00:00 |
| pd_time_zone | varchar(255) | NO | | |
| pd_source | varchar(255) | YES | | |
| pd_source_type | tinyint(2) | NO | | 0 |
| pd_source_name | varchar(255) | YES | | |
| pd_user_agent | varchar(255) | YES | | |
| pd_is_skip | tinyint(1) | NO | | 0 |
| pd_subscriber_id | varchar(255) | YES | | |
| pd_applicatlon | varchar(255) | YES | | |
| pd_is_visible | tinyint(1) | NO | | 1 |
| pd_artist_id | int(11) | YES | MUL | |
| pd_album_id | int(11) | YES | MUL | |
| pd_country_code | char(2) | NO | | — |
| played_pd_played_id_pk_seq | int(11) | NO | | 0 |

The fields shown in Table 1 and their contents may include:

pd_user_id_pk_fk—registered user ID.
pd_subscriber_id—Client platform ID.
pd_remote_addr—Originating IP address for play event.
pd_time_zone—Offset from GMT for client local time.
pd_country_code—The two-letter ISO country code returned by GeoIP for the IP address.
pd_shuffle—Media player shuffle mode flag (0=non-shuffle, 1=shuffle).
pd_souree—Source of play event track:
Library—Track from local user library
MusicStore—Clip from music store supported by music player
   pd_source_type—Code for type of play event based on pd_source:
0—true play event
1—Constructed play event
−1—play event
   pd_source_name—Text name of particular source (typically assigned by user) of the play event.
   pd_playlist_name—Name of playlist returned by music player.
   pd_track_id, pd_artist_id, pd_album_id—The catalog track, artist, and album IDs for resolved play event. If a track cannot be resolved against the catalog at the time of the play event, all three of these columns will have the same value greater than or equal to “1000000000”.
   pd_orphan_id—ID of the track record in the orphan database if the track could not be resolved against the MusicStrands' catalog at the time of the play event (deprecated).
   pd_played_id_pk—ID of play event record in ds database played table.
   pd_begin_time, pd_end_time—GMT for start and end of play event.
   pd_is_skip—Track skipped flag (0=played, 1=skipped).

In one embodiment, legitimate values for Table 1 fields include but are not limited to:
018D42HX8—MS MyStands for Windows
397P88MW3—MS MyStrands for Mac
912T64M2—MS Amorok
912T64M3—MS Amorok Plugin
143G69XC2—MS J2ME Mobile
189Q54MK3—MS.NET Mobile
592Z11AB4—MS Symbian Mobile
374S66AU9—MS Labs
DEVTEST—MS Testing

In one embodiment, the contents of the pd_source and pd_playlist name items depend on the listening scenario and the client as shown in Table 2. In Table 2, “dpb” means “determined by player” and of course “nA” means “not applicable”. “pl_name” means the playlist name as known to the music player and “lib_name” means the library name as known to the music player. “shd_name” for the Mac client means the name the user has set as the iTunes->Preferences->Sharing->Shared name. Library and Musicstore may be the actual text strings returned by the player. Finally, “-” means that the items get assigned the null string as a value, either because, or regardless, of what the client may have sent.

TABLE 2

| | library | | | | | |
|---|---|---|---|---|---|---|
| | mode | | | | | |
| | local | local | shared | shared | store | — |
| client | song | playlist | song | playlist | clip | radio |
| MyStrands/Win | Library | — | — | — | Musicstore | — |
| | dbp | pl_name | lib_name | pl_name | dbp | dbp |
| MyStrands/Mac | — | — | — | — | Musicstore | — |
| | lib_name | pl_name | shd_name | pl_name | — | lib_name |
| Amorok | Library | ? | ? | ? | na | ? |
| | ? | ? | ? | ? | na | ? |
| Amorok Plugin | — | — | na | na | na | — |
| | — | — | na | na | na | — |
| J2ME Mobile | — | — | na | na | na | — |
| | — | — | na | na | na | — |
| .NET Mobile | — | — | na | na | — | — |
| | — | — | na | na | — | — |
| .NET Mobile | Library | — | na | na | Musicstore | ? |
| (could be) | dbp | pl_name | na | na | dbp | ? |
| Symbian Mobile | — | — | na | na | na | — |
| | — | — | na | na | na | — |
| Symbian Mobile | Library | Library | na | na | Musicstore | ? |
| (could be) | dbp | pl_name | na | na | dbp | ? |

The orphan_track and resolved_track tables in the orphan database 508 may contain additional supporting information for possible resolution of tracks that could not be resolved when the play event was logged. Tables 3 and 4 present embodiments of column structures of the played, orphan_track, and resolved_track tables, respectively. In one embodiment, raw track information may be retrieved from a Backend Resolver 520 API.

TABLE 3

| Field | Type | Null | Key | Default |
|---|---|---|---|---|
| ot_orphan_id_pk | int(11) | NO | PRI | 0 |
| ot_user_id | int(11) | NO | MUL | 0 |
| ot_playlist_id | int(11) | YES | | |
| ot_track_name | varchar(255) | YES | | |
| ot_artist_d | varchar(255) | YES | | |
| ot_album_d | varchar(255) | YES | | |
| ot_track_hash | varchar(255) | YES | | |
| ot_artist_hash | varchar(255) | YES | | |
| ot_album_hash | varchar(255) | YES | | |
| ot_tags | varchar(255) | YES | | |

TABLE 4

| Field | Type | Null | Key | Default |
|---|---|---|---|---|
| rtr_resolved_track_id_pk | int(11) | NO | PRI | |
| rtr_timestamp | timestamp | YES | | CURRENT_TIMESTAMP |
| rtr_source | varchar(255) | NO | | |
| rtr_extra | varchar(255) | YES | | |
| rtr_track | varchar(255) | NO | | |
| rtr_artist | varchar(255) | NO | | |
| rtr_album | varchar(255) | NO | | |
| rtr_score | double | YES | | |
| rtr_track_id | int(11) | YES | | |
| rtr_artist_id | int(11) | YES | | |
| rtr_album_id | int(11) | YES | | |

In one embodiment, to decouple the LUMA build process 500 from other activity in the ds database 128, the played events in the played table are buffered in the played event buffer 518 into one or more copies of the played table in the played event buffer bds database 516. The played table in the bds database 516 may have the same or similar structure as shown in Table 1 for the source played table of ds database 128.

In an embodiment, a MySql playstream segmentation (ps) database 510 may be used to maintain data, in some cases keyed to user IDs, needed for the segmentation operation. Because the contents of this database may be constantly changing, a framework such as iBATIS may be used as the access method.

In a particular embodiment, in order to support the dynamic segmentation of played events accumulated in the played table of the ds database 128 into playstreams, a detection table is maintained for mapping the ID of each user (dt_user_id_pk_fk=pd_user_id_pk_fk) into the ID in the played table for the last played item (dt_played_id_pk=pd_played_id_pk) actually included in a playstream and the ID of the last playstream extracted (dt_stream_id). Table 5 presents an embodiment of a column structure of the detection table in the ps database that implements this mapping.

TABLE 5

| Field | Type | Null | Key | Default |
|---|---|---|---|---|
| dt_detection_id_pk | int(11) | NO | PRI | 0 |
| dt_user_id_pk_fk | int(11) | NO | MUL | 0 |
| dt_played_id_pk | int(11) | NO | | 0 |
| dt_alt_played_id_pk | int(11) | NO | | 0 |
| dt_stream_id | int(11) | NO | | 0 |
| dt_source_type | int(11) | NO | | 0 |
| detection_dt_detection_id_pk_seq | int(11) | NO | | 0 |

Events in the played table may be processed in blocks. In an embodiment, to track the last played event of the last processed block, an extraction table may be maintained that includes only the last processed event ID. Table 6 presents an embodiment of a column structure of the extraction table in the ps database 510 that maintains this value.

TABLE 6

| Field | Type | Null | Key | Default |
|---|---|---|---|---|
| extraction_ex_extraction_id_seq | int(11) | NO | | 0 |

In a particular embodiment, to keep track of the last ID assigned to a playstream for a user, a stream table may be maintained for mapping the ID of each user (st_user_id_pk_fk pd_user_id_pk_fk) into the last playstream converted into an rpf file (st_rpf_id). Table 7 presents an embodiment of the column structure of a stream table in the ps database 510 that implements this mapping.

TABLE 7

| Field | Type | Null | Key | Default |
|---|---|---|---|---|
| st_stream_id_pk | int(11) | NO | PRI | 0 |
| st_user_id_pk_fk | int(11) | NO | MUL | 0 |
| st_rpf_id | int(11) | NO | | 0 |
| stream_st_stream_id_pk_seq | int(11) | NO | | 0 |

To keep track of the last ID assigned to a playlist, a single-row table must be maintained that contains the last assigned playlist ID (lst_playlist_id). Table 8 presents an embodiment of a column structure of the list table in the ps database 510 that implements this mapping.

TABLE 8

| Field | Type | Null | Key | Default |
|---|---|---|---|---|
| lst_playlist_id | int(11) | NO | | 0 |

In a particular embodiment, a single-row luma2uma table may be used to store the ID of the last RPF file from the rpf playlist directory 506 that has been combined into an input rpf file for the UMA build pipeline in playlist analyzer 124 (see FIG. 1). Table 9 presents an embodiment of a column structure of a luma2uma table in the ps database 510 that implements this mapping.

TABLE 9

| Field | Type | Null | Key | Default |
|---|---|---|---|---|
| l2u_playlist_id | int(11) | NO | | 0 |

In one embodiment, playstreams detected and extracted from the played table of the ds database 128 may be stored in playstreams archive 512 as individual files in a hierarchical directory structure keyed by the 32-bit pd_user_id_pk_fk and a 32-bit playstream ID number. In one embodiment, the 32-bit pd_user_id_pk_fk may be represented as a four byte string u₃u₂uᵢuₒ and the 32-bit playstream ID number be represented by the four byte string p₃p₂pᵢpₒ, then the fully-qualified path file names for playstream files may have the form:

archive_path/u₃/u₂/u₁/u₀/p₃/p₂/p₁/p₀
where archive_path is the root path of the playstream archive.

In an embodiment, each playstream file may contain relevant elements from the played table events for the tracks in the playstream. The format may consist of a first line which contains identifying information for the playstream and then n item lines, one for each of the n tracks in the playstream.

The first line of the playstream file may have the format:

pd_user_id_pk_fk pd_subscriber_id pd_remote_addr pd_time_zone pd_country_code pd_source pd_playlist_name pd_shuffle stream_begin_time stream_end_time
where the items with the “pd_” suffix are the corresponding items from the first play event in the stream, stream_begin_time is the pd_begin_time of the first event in the play stream, and stream_end_time is the pd_end_time of the last event in the play stream. All items are space separated and last item is followed by the OS-defined EOL separator. In one embodiment, a necessary condition for play events to be grouped into a playstream may be that they all have the same value for the first six items in the first line of the playstream file.

The remaining n lines for the tracks in the playstream have the format:

pd_played_id_pk pd_track_id:pd_artist_id:pd_album_id pd_is_skip
where the items with the “pd_” suffix may be the corresponding items from the play event for the track.

As shown in FIG. 5, in an embodiment, there are two primary processes involved in translating raw events in the played table of the ds database 128 into rpf playlists that can be fed into an instance of the UMA harvester 126 to build LUMA 118. The first process segments sequences of played events into playstreams in the playstream segmenter 530 for storage in the playstreams archive 512. The second process converts those playstreams into rpf playlists in the playstream to rpf playlist converter 504. These two operations may be implemented as two independent process threads which are asynchronous to each other and to the other processes inserting events into the played table. Therefore, the ps database 510 maintains data needed to arbitrate data transfers between these processes.

In an embodiment, the playstream segmenter 530 segments playstreams by a process that examines events in the played table for a given user to determine groups of sequentially contiguous events which can be segmented into playstreams.

### Defining and Segmenting Playstreams

In a particular embodiment, two criteria may be used to find segmentation boundaries between groups of played events. The first criteria may be that all events in a group must have the same values for the following columns in the played table:
1. pd_subscriber_id—Client platform ID.
2. pd_remote_addr—Originating IP address for play event.
3. pd_time_zone—Offset from GMT for client local time.
4. pd_country_code—The two-letter ISO country code returned by GeoIP for the IP address.
5. pd_shuffle—Media player shuffle mode flag.
6. pd_source—Source of play event track.
7. pd_source_name—Text name of particular source (typically assigned by user) of the play event.
8. pd_playlist_name—Name of playlist returned by music player.

In a particular embodiment, two consecutive events which differ in any of these values may define a boundary between two consecutive playstreams.

The second criteria for defining a playstream may be based on time gaps between sequentially tracks. Two consecutive tracks for which the pd_begin_time of the second event follows the pd_end_time of the first event may also define a boundary between two consecutive playstreams.

As already noted, the playstream extraction process is asynchronous with processes for inserting events into the played table. In a particular embodiment, both processes run continuously, with the user ID to played event ID mapping in the detection table of the ps database 510 used to arbitrate the data transfer between the processes.

The playstream-to-playlist converter 504 processes the extracted playstreams into rpf format playlists. This processing mainly involves removing redundant events and resolving orphan events that could not be resolved at the time the event was generated.

In an embodiment, raw playstreams may contain a valid colon-delimited track:artist:album triple, or a null triple 0:0:0 and an orphan ID for each event. In addition, a playstream can contain duplications which are not of interest for a playlist. The playstream-to-playlist converter resolves the orphans it can with the aid of the resolver 509 and the resolved_track table in the orphan database.

The ps database 510 may contain the state information for the asynchronous playstream-to-rpf conversion process. For each user ID, the stream table may contain the playstream ID (e.g., st_rpf_id) of the last playstream actually converted to an rpf playlist and the detection table may contain the playstream ID (e.g., dt_stream_id) of the last playstream actually extracted by the playstream segmenter 530. In one embodiment, the playstream segmenter 530 is a functional block of the playstream harvester 130 (see FIG. 1). The playstream-to-rpf converter 504 uses these two values to determine the IDs of the playlists to be converted to rpf playlists.

### CTL Events

An important question in defining CTL events is whether the playstream analyzer 108 should generate events on a per-playstream basis or for aggregate statistics, or both. On one hand, if CTL events are generated on a per-playstream basis, the number could be large, and grow with the number of users. On the other hand, because the LUMA builder operates in an asynchronous mode, a natural period over which to aggregate statistics would be one activation of the LUMA processes. Thus the actual time period encompassed by the playstreams processed in a single activation of the LUMA processes could vary from activation to activation, and so additional states would have to be maintained to regularize the aggregated statistics.

CTL events may generated on a per playstream/per-playlist basis and stored in the ctl database 514. That is a CTL PLAYSTREAM_HARVEST event may be generated for each extracted playstream and a CTL PLAYLIST_HARVEST event may be generated for each playstream converted to an rpf playlist.

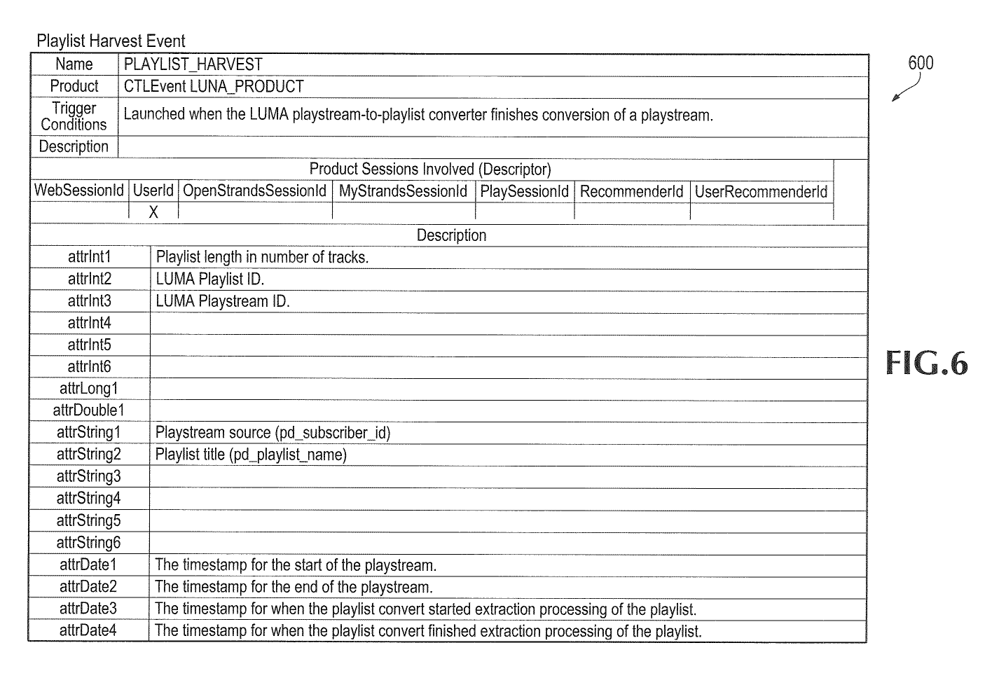

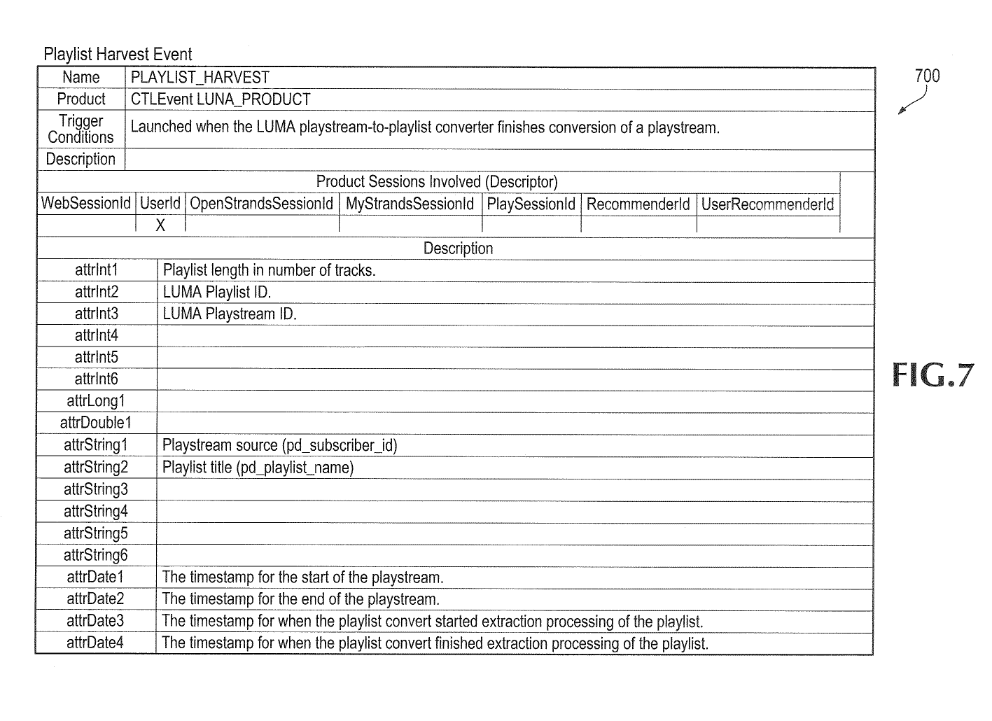

FIG. 6 and FIG. 7 present the specification of the playstream and playlist CTL events. Referring to FIG. 6, the PLAYSTREAM_HARVEST event 600 is launched each time the LUMA playstream extractor extracts a playstream from the played table of the ds database 128 for a playstream. The only product session involved is the Userld reference; while it might be possible to use either a session ld or Play session ld for the playstream ID generated by the segmenter 530. The rest of the event record contains the playstream length, the playstream ID, the number of unresolved orphan tracks, the number of skipped tracks, and a “0”/“′1” indication of whether the playstream was generated in shuffle mode. The first three string parameters provide information on the virtual, geographic location, and time-zone of the client. The fourth parameter is the lowercased values of the pd_subscriber_id from the ds database for playstream. The fifth parameter is the lowercased value of the pd_source from the ds database for playstream if this value is a non-null string, otherwise it is the string “unknown”. The last parameter is the playlist name returned by the client from pd_playlist_name. The first two date parameters and the start and ending time of the playstream. The last two date parameters are the actual start and stop time for when the extractor processed the playlist.

Referring to FIG. 7, the PLAYLIST_HARVEST event 700 is launched each time the LUMA playstream-to-playlist converter converts a playstream from the playstream archive into an rpf playlist to be fed into the UMA build pipeline. Because this event is associated with a production of a playlist in the same way as the PLAYLIST_HARVEST launched by the playlist harvester, the format of this event is designed to conform to that of the harvester event to the extent possible. As for the PLAYSTREAM event, the rest of the event record contains the integer parameters for reporting aggregated statistics of the playlists identified by the playstream-to-playlist converter, namely the playlist length, the playlist ID, and the source playstream ID. Similarly, the string parameters provide information on the virtual and geographic location of the client, and on the time the playstream was actually played. The date parameters are the actual start and stop time for when the playstream-to-playlist converter processed the playlist.

FIG. 8 is a block diagram for a particular embodiment of the playstream extraction process 800. The playstream extraction process herein described assumes identifiers for playstreams are sequential. The process 800 starts at block 802 where the list for which played events exist in the played table in the ds database 128 is retrieved, the list may be named pd_user_id_pk_fk. Process 800 flows to block 804 where the values of the last played event (last_played_id) and the last determined stream (last_stream_id) for the current user (user_id) are retrieved from the detection table in the ps database 510. The process flows to block 806 where the list of all events in the played table of the user_id whose ID is greater than the last_played_id is retrieved. At block 808, an iterative process begins that is to be repeated until no more playstreams can be found in the list extracted in block 806. At block 808, sequentially step through the list of events checking for predetermined segment criteria such as discussed above until a segment boundary is identified, the segment boundary ID may be next_last_played_id. At block 810, orphan events are identified for instance by identifying an orphan ID instead of a resolved track ID. If the orphan ID does not exist in the resolved_track table of the orphan database 508, then retrieve the information for this orphan ID from the orphan_track table and call the resolver 509 in an attempt to resolve the orphan. If the resolver 509 successfully resolves the orphan and returns a track ID, artist ID, and album ID, then update the resolved track table (resolved_track table) with the track ID, artist ID, and album ID for this orphan ID. If the orphan ID does exist in the resolved_track table of the orphan database, replace the track ID, artist ID, and album ID in the playstream event with the orphan track ID, artist ID, and album ID retrieved from the resolved_track table. At block 812, events from last_stream_id+1 to next_last_stream_id are extracted and saved in the playstream archive 512 as playstream last_stream_id+1 for the current user_id. At block 814, process 800 includes updating the detection table in the ps database 510 with next_last_played_id+1 for this user_id. If there are additional playstreams in list extracted in block 806, repeat blocks 808-814 until no more playstreams can be found in the list extracted in block 806. In an embodiment, the length of the delay between events which define a playstream boundary according to the second criteria above for playstream segmentation is a parameter in the application properties file that may be set to any non-negative value. The unit of delay on this parameter is assumed to be seconds.

FIG. 9 is a block diagram for a particular embodiment of the playstream-to-playlist converter process 900. The process 900 may be asynchronous with the playstream extraction process. Both processes may run continuously and so a process may be provided to arbitrate the data transfer between the playstream extraction process 800 (described with reference to FIG. 8) and playstream-to-rpf converter process 900. The user ID to stream ID mapping in the detection table and the user ID to rpf ID mapping in the stream table may provide the state information about the two processes for regulating the data transfer.

The playstream-to-playlist converter process herein described assumes identifiers for playstreams are sequential such that the last playstream identified will have an ID indicating that it was the last in time playstream to be identified. Process 900 begins at block 902 by retrieving the current playstream list (pd_user_id_pk_fk) for which the playstream ID (dt_stream_id) in the detection table in the ps database 510 is greater than the last identified raw playlist (st_rpf_id) in the stream table. At block 904, for each value user_id in the list retrieve the value of the last_stream_id for the selected user_id from the detection table in the ps database 510 and retrieve the value of the last_rpf_id for the selected user_id from the stream table in the ps database 510. The process flows to block 906 where for each playstream with this_stream_id from last_stream_id+1 to last_stream_id an iterative process begins with removing all but one instance of each event with duplicate track IDs or orphan IDs, regardless of whether they are sequential or not, from the playstream. At block 908, the track ID, artist ID, and album ID are extracted for each item in the processed playstream into an rpf format playlist. At block 910, the rpf playlist is stored in the watched directory at the start of the UMA build system playlist analyzer 106 with a 4 byte playstream user ID as the playlist Member ID, and the lower 24 bits of last_playlist_id+1 as the lower 3 bytes of the Playlist ID the upper bytes of the Playlist ID a code for the playstream source according to Table 10.

TABLE 10

| Source | Member ID |
|---|---|
| MS MyStrands for Windows | 1 |
| MS MyStrands for Mac | 2 |
| MS Amorok | 3 |
| MS Amorok Plugin | 4 |
| MS J2ME Mobile | 5 |
| MS .NET Mobile | 6 |
| MS Symbian Mobile | 7 |
| MS Labs | 8 |
| MS Testing | 9 |

At block 912, increment last_playlist_id and update the list table in the ps database 510 with last_playlist_id. At block 914, update the stream table in the ps database with this_stream_id for this user_id. At block 916 the process ends.

### PCC Builder Process

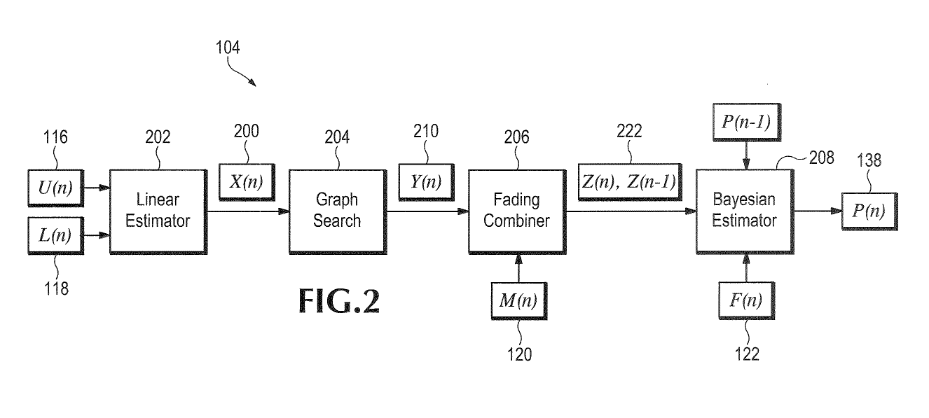

FIG. 2 illustrates a dataflow diagram of an embodiment of the PCC builder 104. At this level the process operates as a four stage pipeline. The initial linear estimator 202 combines the playlist-style intentional association data U(n) 116 with the playstream-style spontaneous association data L(n) 118 based on a model for similarity (such as an ad hoc model or Bernoulli model as discussed above) to produce the data input X(n) 200. This data X(n) 200 is input to a second stage graph search 204, wherein graph search processing produces a preliminary PCC dataset, Y(n) 210. The Y(n) data 210 is then combined with metadata MPCCs, M(n) 120 in the fading combiner 206 to account for media items that are not on any playlists or in any playstreams and to fade out the M(n) 120 data as the media items begin to appear in playlists or play streams or to fade out M(n) 120 if the media items fail to appear on playlists or playstreams within a predetermined time period from when they first appear in the media item databases from which the M(n) 120 is generated. The output of fading combiner 206 is Z(n) and Z(n−1) which is input to an estimator 208 where it is combine with feedback data F(n) to generate final recommender PCCs P(n).

To start, in a particular embodiment the linear estimator 202 receives the playlist and playstream data L(n) 116 and U(n) 118.

Linear Estimator for Estimating Co-Occurrences from Playlist and Playstream Data

The Bernoulli model, discussed above for determining co-occurrences to determine datasets for UMA 116 and LUMA 118 is presented below. The model postulates that the random occurrence of two items and on a playlist or in a playstream given that either item occurs on the playlist or in the playstream is modeled as a Bernoulli trial with probability:

$$η = \frac{{ρ}_{ij }}{2 - {ρ}_{ij}}$$

where 0≦ρ_{i,j}≦1 is some symmetric measure (ρᵢⱼ=ρⱼᵢ) of the assumed “similarity” of item i and j. In this model, the number of co-occurrences of items i and j is modeled by a binomial random variable xᵢⱼ(n) and the expected number of co-occurrences is:

$${\overline{x}}_{ij} ( n ) = x ( i , j ; n ) \frac{{ρ}_{ij}}{2 - {ρ}_{ij}}$$

where x(i, j; n) is the number of playlists or playstreams that include item i or item j.

In FIG. 2, PCC builder 104 utilizes two independent random processes U(n) or uᵢⱼ(n) and L(n) or lᵢⱼ(n), from which measurements are available to derive an estimate X(n) or xᵢⱼ(n) for x̅ᵢⱼ(n). For the Bernoulli model of co-occurrences, a reasonable choice is a simple maximum likelihood estimator of the form:

xᵢⱼ(n)=\hat{η}(n)x(i,j;n)

where \hat{η}(n) is the estimated probability that both items i and j occur on a playlist or playstream if either one does, and x(i, j; n) is some preferred choice for the total number of playlists and playstreams that include item i or j.

A starting assumption for the estimator is that it may be desirable to arbitrarily weight the relative contribution of the playlist and playstream data in any estimate. The most straightforward way to do this is by defining two weighting constants 0≦αᵤ, αₗ,≦1 such that the effective number of co-occurrences is αᵤuᵢⱼ(n) and αₗlᵢⱼ(n), and the total number of playlists including items i or j or as defined below is αᵤ u(i, j; n) and αₗl(i, j; n). The estimate for η then is:

$$\hat{η} ( n ) = \frac{{α}_{u} {u}_{ij} ( n ) + {a}_{l} {1}_{ij} ( n )}{{α}_{u} u ( i , j ; n ) + {α}_{l} l ( i , j ; n )}$$

The estimator can then be re-expressed as:

$$\begin{matrix}{x}_{ij} ( n ) = \frac{{α}_{u} x ( i , j ; n )}{{α}_{u} u ( i , j ; n ) + {α}_{l} l ( i , j ; n )} {u}_{ij} ( n ) + \\ \frac{{α}_{l} x ( i , j ; n )}{{α}_{u} u ( i , j ; n ) + {α}_{l} l ( i , j ; n )} {1}_{ij} ( n ) \\ = {k}_{u} {u}_{ij} ( n ) + {k}_{l} {1}_{ij} ( n )\end{matrix}$$

For some specific choices of αᵤ, αₗ and x(i, j; n), the general estimator reduces to specific linear estimators:

αᵤ=1, αₗ=1, x(i,j;n)=u(i,j;n)+l(i,j;n)—The resulting estimator

xᵢⱼ(n)=uᵢⱼ(n)+lᵢⱼ(n)

with unweighted contributions by uᵢⱼ(n) and lᵢⱼ(n) turns out to be a simple minimum variance estimator as described below.

x(i,j;n)=αᵤu(i,j;n)+αₗl(i,j;n)—For this case, the estimator

xᵢⱼ(n)=αᵤuᵢⱼ(n)+αₗlᵢⱼ(n)

is a weighted minimum variance estimator. The weights should reflect some independent assessment of the relative value uᵢⱼ(n) and lᵢⱼ(n) contribute to the PCCs driving the recommender. Note the value of x(i, j; n) for this estimator implies that the popularities in the items Xᵢ(n) and Xⱼ(n) of the data set built from Uᵢ(n), Uⱼ(n), Lᵢ(n) and Lⱼ(n) must be the weighted sum of the popularities Uᵢ(n), Lᵢ(n) and Uⱼ(n), Lⱼ(n), respectively.

αᵤ=αₗ, x(i,j;n)=αᵤu(i,j;n)+αₗl(i,j;n)—The general case of the resulting estimator

$${x}_{ij} ( n ) = \frac{{α}_{u} u ( i , j ; n ) + {α}_{l} l ( i , j ; n )}{u ( i , j ; n ) + l ( i , j ; n )} {u}_{ij} ( n ) + \frac{{α}_{u} u ( i , j ; n ) + {α}_{l} l \vert ( i , j ; n )}{u ( i , j ; n ) + l ( i , j ; n )} {1}_{ij} ( n )$$

is an unweighted minimum variance estimator if the popularities in the items Xᵢ(n) and Xⱼ(n) are adjusted to be the weighted sum of the popularities in Uᵢ(n), Lᵢ(n) and Uⱼ(n), Lⱼ(n), respectively. This form of the co-occurrence estimator may be useful for accommodating mathematical requirements in the subsequent graph search phase of the PCC build process.

x(i,j;n)=u(i,j;n)+l(i,j;n)—The general case of the resulting estimator

$${x}_{ij} ( n ) = {α}_{u} \frac{u ( i , j ; n ) + l ( i , j ; n )}{{α}_{u} u ( i , j ; n ) + {α}_{l} l ( i , j ; n )} {u}_{ij} ( n ) + {α}_{l} \frac{u ( i , j ; n ) + l ( i , j ; n )}{{α}_{u} u ( i , j ; n ) + {α}_{l} l ( i , j ; n )} {1}_{ij} ( n )$$

results in inconsistent datasets Xᵢ(n). Because this choice for x(i, j; n) implies the popularities in Xᵢ(n) and Xⱼ(n) are the sum of Uᵢ(n), Lᵢ(n) and Uⱼ(n), Lⱼ(n), respectively, but the co-occurrences are a weighted estimate, the number of playlists and playstreams implied by xᵢ(n), xⱼ(n), and xᵢⱼ(n) will be inconsistent with x(i, j; n). Furthermore, xᵢ(n), xⱼ(n) cannot be adjusted for every i and j to be consistent. The special case αᵤ=αₗ reduces to the unweighted minimum variance estimator.

Graph Search for Determining Similarity from Co-Occurrence Estimate

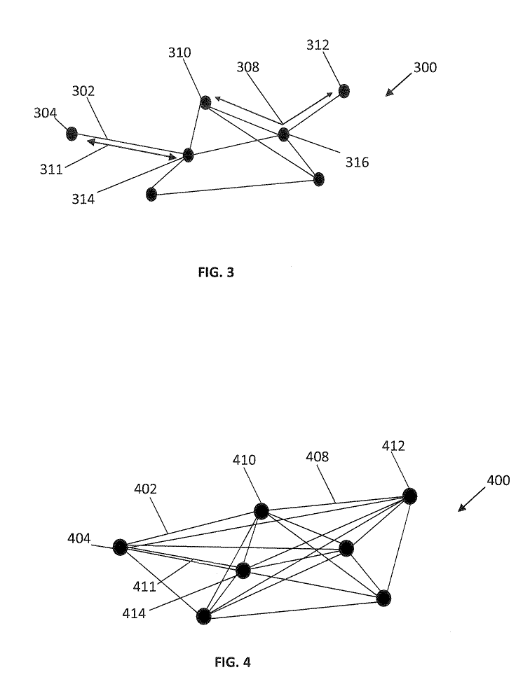

The following discussion refers to the graphs illustrated in FIG. 3 and FIG. 4. FIG. 3 illustrates a graph 300 constructed of data X(n) 200. Graph 300 comprises a weighted graph representation for the associations within the collection of media items resulting from a combination of U(n) 116 and L(n) 118. Each edge (e.g., 302) between media items nodes (e.g., 304, 310 and 312) indicates a weight representing the value of the metric for the similarity between the media items. In one embodiment, graph 300 may be used to construct dataset Y(n) 210 by executing a search of graph 300 to produce dataset Y(n) 210 represented by graph 400 shown in FIG. 4. In some embodiments, where graph 300 is generated based on principled methods to model co-occurrences of items i and j from playlist and playstream data the graph search of graph 300 may produce a graph 400 representing data Y(n) 210 having consistent similarity data. Thus, in such an embodiment where there are multiple paths connecting a pair of nodes in graph 400 the resulting similarity data may yield the same similarity value between any given pair of nodes in graph 400 irrespective of the path between the two nodes used to calculate the similarity data. In other such embodiments, for any given pair of nodes in graph 400 where there are multiple paths between the nodes, the similarity value may be at least as great as the net similarity value for the path between the nodes with the greatest similarity value

In an embodiment, a graph search may identify all paths in X(n) graph 300 between all pairs of nodes comprising a head node and a tail node (or originating node and destination node). For a given head node, a search may determine all other nodes in graph 300 that are connected to the head node via some continuous path. For instance, head node 310 is indirectly connected to tail node 312 via path 308 through an intervening node 316. Head node 304 is directly connected to tail node 314 along path 311 via edge 302.

In Y(n) graph 400 the paths identified in graph 300 are represented as weighted edges (e.g., 402) connecting head nodes to tail nodes in graph 400. The weight attached to an edge is a function indicating similarity and/or distance which correlates to the number of nodes traversed over a particular path joining two nodes in the X(n) graph 300. For instance, for head node 410 (corresponding to node 310 of graph 300) and tail node 412 (corresponding to node 312 in graph 300) the weight on edge 408 correlates to path 308 in graph 300. The weight on edge 411 connecting nodes 404 and 414 correlates to path 311 in graph 300.

In an embodiment, for similarity, the weight on an edge joining a head node to a highly similar tail node is greater than the weight on an edge joining the head node to a less similar tail node. For distance the opposite is the case: the distance weight on an edge joining the head node to a highly similar tail node is less (they are closer) than the weight on an edge joining the head node to a less similar tail node.

Referring again to FIG. 2, in an embodiment, after both items in a specific correlation first appear on playlists or playstreams, the fading combiner 206 in the third-stage of the pipeline addresses the cold start problem by combining metadata-derived similarity data M(n) 216 with the preliminary PCC dataset Y(n) 210 such that the contribution of the metadata M(n) 216 declines and the contribution of Y(n) 210 increases over time.

In practice, variants of the second and third stage functionality may be combined into a single processing operation in several ways. For instance, in one embodiment, a Bayesian estimator 208 tunes the composite Z(n) 222 in response to user feedback F(n) 218. User feedback may be short-term user feedback Fₛ(n) and/or long-term user feedback Fₗ(n)) to produce the final PCC dataset P(n) 218. Long and short term user feedback is discussed in further detail below.

### Fading Combiner for Incorporating MPCC Data Prior Information

Referring again to FIG. 2, in a dataset for Zᵢ(n) 222 generated by fading combiner 206 items zᵢⱼ(n) are random variables computed from the values yᵢⱼ(n) derived by the graph search 204 procedure and the metadata similarity value mᵢⱼ.

Given an initial update instant nᵢ in which both item i and item j first appear on playlists or in playstreams, zᵢⱼ(n) may be computed as follows:

$${z}_{ij} ( n ) = \{ \begin{matrix}{m}_{ij} & n \leq {n}_{1} \\ {β}^{n - {n}_{1}} {m}_{ij} + ( 1 - {β}^{n - {n}_{1}} ) {y}_{ij} ( n ) & n > {n}_{1}\end{matrix}$$

Using this formula the contribution of m(n) is faded out and the contribution of yᵢⱼ(n) is faded in, reflecting an assumption that even relatively small values of yᵢᵢ(n) should be used as yᵢⱼ(n) if they have persisted long enough because they represent rare but interesting similarities between i and j. A choice for the coefficient β under this assumption is:

β=e^{-1/N}

where N is the number of updates after which the contribution of mᵢⱼ should be less than roughly ⅓.

A variety of other processes and procedures based on assumptions about the relationship between metadata similarity and the model of similarity implied by the graph search procedure on the co-occurrence data may also be executed by the adaptive recommender system 100 and claimed subject matter is not limited in this regard. For instance, the update instant n₁ at which fading out of the metadata contribution begins could be delayed until the number of correlations between every item on the path between i and j exceeds a certain number. The graph search process would view the number of correlations between two items as 0 until a threshold is exceeded. Another approach could be based on deriving an estimate for the variance of the yᵢⱼ(n) and delaying n₁ until that variance falls below a threshold value after both items i and j first appear on playlists or in playstreams.

### Tuning PCC Values Using User Feedback Data

### FUMA

### Adapting to User Feedback

PCC builder 104 in FIG. 2 incorporates and adapts the PCC values in response to accumulated user feedback, F(n) 122 generated by the user feedback analyzer 114. In a general sense, the process fine tunes the PCC values based on user reactions to their experiences with products using the PCC values based on a model of feedback processes. In one embodiment, the feedback process characterizes the experience the user tried to create through his or her feedback and compares that with the experience as initially presented by the system to derive as estimate of the difference.

It should be noted that in the embodiment described herein, the task of adapting the recommender to better match aggregate audience preferences is addressed. However, personalizing recommendations may be accomplished for instance by looking at results for individual users and claimed subject matter is not limited in this regard. Adapting the recommender kb 102 to aggregate audience preferences may be implemented in a variety of ways. Thus, the embodiments described herein are intended for illustrative purposes and do not limit the scope of claimed subject matter.

### Nature of the User Feedback Data

PCC datasets may be organized on a per item basis. The PCC dataset for item i may include a set of random variables r_{i,j}, each of which is a monotonic estimate of the actual similarity ρ_{i,j} between item i and item j. The PCC dataset also includes a random variable qᵢ which is an estimate of the popularity σᵢ of item i.

In an embodiment, various sources of data that can be used in the recommendation process including: UMA 116, an analogous pair of popularity q′ᵢ(t) and association estimates r′_{i,j}(t) based on user listening behavior using the LUMA 118 (see FIG. 1 and FIG. 5) built from client data and the user feedback such as replays/skips and thumbs up/thumbs down ratings.

Use of various types of user feedback leverages differences inherent and implicit in various types of feedback. For instance, there may be an essential difference between the replays/skips and the thumbs up/down ratings as listeners come to actually use those features. Aggregate replays/skips data may reflect the popularity arc of a track/artist/album. Aggregate thumbs up/down ratings may reflect something intrinsic about the quality of a track/artist/album. Replays/skips and thumbs up/down ratings data may be a measure of attributes of the specific tracks, or may be indicative of some relationship between the subject item and other preceding tracks. In other words, a thumbs-down rating on a rock track that appears in the context of a number of jazz tracks the listener likes suggests that the rock track is not a good recommendation to a listener who likes the jazz tracks but is not necessarily a useful rating of the inherent quality of the rock track.

Users may interact with media streams built or suggested using data provided by recommender kb 102. The users may interact with these media streams in several ways and those interactions can be divided for example into positive assessments and negative assessments reflecting general user assessments of the items in the streams:

Positive assessments are actions that to some degree indicate a positive reception by the user, for example:
1. plays—User allowed experiences, such as listening to a music track to completion.
2. replays—Explicit user requests that experiences be repeated.
3. thumbs up—Explicit user expressions of approval for items.
4. add to favorites—User adoptions of items as significant preferences.

Negative assessments are actions that to some degree indicate a negative reception by the user, for example:
1. skips—User terminated experiences, such as stopping a music track before completion.
2. thumbs down—Explicit user expressions of disapproval for items.
3. ban—User rejections of items as significant non-preferences.

In interpreting these actions, the context in which the user assessments are made may be accounted for by using the media streams as context delimiters. For instance, when a user bans an item j, (e.g. a Bach fugue) in a context that includes item i (e.g. a Big & Rich country hit), that action indicates something about the item j independently, and about item j relative to the preferred item i. Both types of information are useful in tuning the recommender. The view of media streams as context delimiters, and the user interactions as both absolute and relative assessments of items in those contexts, can be used to adapt the association information encoded in the unadapted PCC dataset Z(n) 222 to produce the final tuned PCC dataset P(n) 138.

Different user actions can be inferred to have different importance for tuning recommendations. Plays, replays, skips, thumbs up, and thumbs down actions suggest more transient responses to items, add-to-favorites and bans suggest more enduring assessments. To reflect this difference, the former user actions may be measured over a short time span, such as over one update instance or period, while the latter user actions may be measured over a longer time span.

The presentation of media items may be organized into sessions. Users may control media consumption during a presentation session by providing feedback where the feedback selections such as replays/skips and thumbs up/down rating features exert influences on the user-experience, for instance:
1. Positively assessed items: Other works by artists of re-played and “thumbs-up” rated items are more likely to be played.
2. Negatively assessed items: Skipped items will not be re-played to the user in the short term, but remain eligible to be automatically re-played in the long-term. Other works by artists of skipped items are less likely to be played in the near term. “Thumbs-down” rated items will never be re-played to the user. Other works by artists of “thumbs-down” rated items are less likely to ever be played.

Based on these considerations information about the attributes of individual media items, and about the relationships between media items from the user feedback data can be extrapolated.

### Processing User Feedback Data

### Bayes Estimation

### For the First Embodiment

In Bayes Estimation, an observed random variable y is assumed to have a density f_{y}(θ; y), where θ is some parameter of the density function. The parameter itself is assumed to be a random variable 0≦θ≦1 with density f_{θ}(θ) referred to as a prior distribution. The problem is to derive an estimate \hat{θ} given some sample y of y and some assumed form for the distributions f_{y}(θ; y) and the prior distribution f_{θ}θ). An important aspect of Bayes estimation is that f_{θ}(θ) need not be an objective distribution as it standard probability theory, but can be any function that has the formal mathematical properties of a distribution that is based on a belief of what it should be, or derived from other data.

Because f_{y}(θ; y) varies with θ, it can be viewed as a conditional density f_{y|θ}(y|θ). The joint density f_{y|θ}(y;θ) of y and (θ) then can be expressed as:

f_{θ|y}(θ|y)f_{y}(y)=f_{y,θ}(y,θ)=f_{y|θ}(y|θ)f_{θ}(θ)

Re-arranging by Bayes Law yields the posterior distribution:

$${f}_{θ \vert y} ( θ \vert y ) = \frac{{f}_{y \vert θ} ( y \vert θ ) {f}_{θ} ( θ )}{{f}_{y} ( y )}$$

Although f_{y}(y) typically is not known, it can be derived from f_{y|θ}(y|θ) and f_{θ}(θ) as:

$${f}_{y} ( y ) = {\int }_{0}^{1} {f}_{y , θ} ( y , θ ) d θ = {\int }_{0}^{1} {f}_{y \vert θ} ( y \vert θ ) {f}_{θ} ( θ ) d θ$$

Given a value for y, the Bayes estimate for θ is the value for which f_{θ|y}(θ|y) has minimum variance. This is just the conditional mean \hat{θ}=E{θ|y} of f_{θ|y}(θ|y).

As a simple example of Bayes estimation, consider the case where f_{y|θ}(y|θ) has a binomial distribution and f_{θ}(θ) has a beta distribution:

$${f}_{y \vert θ} ( y \vert θ ) = ( \begin{matrix}Y \\ y\end{matrix} ) {{θ}^{y} ( 1 - θ )}^{Y - y} \qquad {f}_{θ} ( θ ) = ( X + 1 ) ( \begin{matrix}X \\ x\end{matrix} ) {{θ}^{x} ( 1 - θ )}^{X - x}$$

The joint density then is:

$${f}_{y , θ} ( y , θ ) = ( X + 1 ) ( \begin{matrix}X \\ x\end{matrix} ) ( \begin{matrix}Y \\ y\end{matrix} ) {{θ}^{x + y} ( 1 - θ )}^{( X + Y ) - ( x + y )}$$

From this the marginal can be computed as:

$$\begin{matrix}{f}_{y} ( y ) = {\int }_{0}^{1} {f}_{y \vert θ} ( y \vert θ ) {f}_{θ} ( θ ) d θ \\ = ( X + 1 ) ( \begin{matrix}X \\ r\end{matrix} ) ( \begin{matrix}Y \\ y\end{matrix} ) ( X + Y + 1 ) {( \begin{matrix}X + Y \\ x + y\end{matrix} )}^{- 1}\end{matrix}$$

Taking the quotient yields the beta posterior density:

$${f}_{θ \vert y} ( θ \vert y ) = ( X + Y + 1 ) ( \begin{matrix}X + Y \\ x + y\end{matrix} ) {{θ}^{x + y} ( 1 - θ )}^{( X + Y ) - ( x + y )}$$

The Bayes estimate is the conditional mean E{|y} of f_{θ|y}(θ|y)

$$E \{ θ \vert y \} = \frac{x}{X + Y + 2} + \frac{y}{X + Y + 2} + \frac{1}{X + Y + 2}$$

### First Embodiment of User Feedback System

Referring again to FIG. 2, user feedback 122 (F(n)) may be combined with the PCCs (Z(n) and Z(n−1) 222) generated by the fading combiner 206, to produce a final PCC dataset P(n) 138 to be used by the recommender kb 102 (illustrated in FIG. 1).

The user feedback F(n) 122 in FIG. 2 represents the collection of the independent and relative user interaction data measured on the indicated time scales. The element Fᵢ(n) for item i consists of a vector fᵢ(n) of measurements of the seven above noted user actions for item i without regard to context, and a vector fᵢⱼ(n) of the seven user actions for each item j that occurs in a context with item i:

$${f}_{i} ( n ) = [ \begin{matrix}plays i \\ replays i \\ thumbs up i \\ skips i \\ thumbs down i \\ add to favorites i \\ ban i\end{matrix} ]$$

$${f}_{ij} ( n ) = [ \begin{matrix}plays j in context with i \\ replays j in context with i \\ thumbs up j in context with i \\ skips j in context with i \\ thumbs down j in context with i \\ add to favorites j in context with i \\ ban j in context with i\end{matrix} ]$$

The first five items (plays, replays, thumbs up, skips, thumbs down) may be aggregations over a small number of previous update periods, while the last two items (add to favorites, ban) may be aggregations over a long time scale.

At each update instant n, the number aᵢ(n) of actual presentations of item i and the number aᵢⱼ(n) of actual presentations of item j in the context of item i is known. Let Aᵢ(n) represent the collection of these counts for item i and A(n) represent the collection of all Aᵢ(n). An estimate of the number of presentations dᵢ(n) and dᵢⱼ(n) that the audience actually desired is calculated from the A(n) and F(n), perhaps as the weighted sums:

$${d}_{i} ( n ) = {γ}_{1} {a}_{i} ( n ) + \underbrace{{γ}_{2} {f}_{i , 1} ( n ) + {γ}_{3} {f}_{i , 2} ( n ) + {γ}_{4} {f}_{i , 3} ( n )}_{short term positive} - \underbrace{{γ}_{5} {f}_{i , 4} ( n ) - {γ}_{6} {f}_{i , 5} ( n )}_{short term negative} + \underbrace{{γ}_{7} {f}_{i , 6} - {γ}_{8} {f}_{i , 7}}_{long term} + {γ}_{9}$$

$${d}_{ij} ( n ) = {λ}_{1} {a}_{ij} ( n ) + \underbrace{{λ}_{2} {f}_{ij , 1} ( n ) + {λ}_{3} {f}_{ij , 2} ( n ) + {λ}_{4} {f}_{ij , 3} ( n )}_{short term positive} - \underbrace{{λ}_{5} {f}_{ij , 4} ( n ) - {λ}_{6} {f}_{ij , 5} ( n )}_{short term negative} + \underbrace{{λ}_{7} {f}_{ij , 6} - {λ}_{8} {f}_{ij , 7}}_{long term} + {λ}_{9}$$

where the γₖ and λₖ are arbitrary constants dᵢ(n) and dᵢⱼ(n) could also be computed according to any suitable non-linear functions dᵢ(n)=Γ(fᵢ(n)) and dᵢⱼ(n)=Λ(fᵢⱼ(n)). This model can also be applied to user feedback measured on a “1”-“5” star scale, or any similar rating scheme.

With values aᵢ(n) and aᵢⱼ(n) for the actual number of presentations of item i and of item j in the context of item i, and estimates dᵢ(n) and dᵢⱼ(n) for the imputed desired number of presentations, any number of schemes can be used to compute an estimate pᵢⱼ(n) for the component pᵢⱼ(n) of the PCC item Pᵢ(n). In one embodiment, a Bayesian estimator (as described above) may be used to derive a posterior estimate \hat{p}ᵢⱼ(n) of the value pᵢⱼ(n) most likely to result in the desired number of presentations dᵢ(n) and dᵢⱼ(n), given that the actual presentations aᵢⱼ(n) were randomly generated by the recommender kb 102 and application at a rate proportional to the prior value pᵢⱼ(n) determined by the value zᵢⱼ(n) of the random variable zᵢⱼ(n).

The Bayesian estimator example described above makes the rather arbitrary assumptions that the random variable pᵢⱼ(n), given the actual presentations aᵢ(n) of item i and the expected presentations aᵢ(n)zᵢⱼ(n) of item j in the context of item i, has a beta distribution (omitting the update index n for the moment to simplify the notation):

$${f}_{p} ( {p}_{ij} ) = ( {a}_{i} + 1 ) ( \begin{matrix}{a}_{i} \\ {a}_{i} {z}_{ij}\end{matrix} ) {{p}_{ij}^{{a}_{i} {z}_{i , j}} ( 1 - {p}_{ij} )}^{{a}_{i} - {a}_{i} {z}_{ij}}$$

and that the random variable dᵢⱼ(n) conditioned on pᵢⱼ(n) has a binary distribution:

$${f}_{d \vert p} ( {d}_{ij} \vert {p}_{ij} ) = ( \begin{matrix}{d}_{i} \\ {d}_{ij}\end{matrix} ) {{p}_{ij}^{{d}_{ij}} ( 1 - {p}_{ij} )}^{{d}_{i} - {d}_{ij}}$$

The resulting random variable pᵢⱼ(n) conditioned on dᵢⱼ(n) also is beta distributed:

$${f}_{p \vert d} ( {p}_{ij} \vert {d}_{ij} ) = ( {a}_{i} + {d}_{i} + 1 ) ( \begin{matrix}{a}_{i} + {d}_{i} \\ {a}_{i} {z }_{ij} + {d}_{ij}\end{matrix} ) {{p}_{ij}^{{a}_{i} {z}_{ij} + {d}_{ij}} ( 1 - {p}_{ij} )}^{( {a}_{i} + {d}_{i} ) - ( {a}_{ij} {z}_{ij} + {d}_{ij} )}$$

The Bayesian estimate for \hat{p}ᵢⱼ(n)=E {pᵢⱼ(n)|dᵢⱼ(n)} then is:

$$\begin{matrix}{\hat{p}}_{ij} ( n ) = \frac{{a}_{i} ( n )}{{a}_{i} ( n ) + {d}_{i} ( n ) + 2} {p}_{ij} ( n ) + \frac{1}{{a}_{i} ( n ) + {d}_{i} ( n ) + 2} {d}_{ij} ( n ) + \\ \frac{1}{{a}_{i} ( n ) + {d}_{i} ( n )} \\ = {k}_{p} {p}_{ij} ( n ) + {k}_{d} {d}_{ij} ( n ) + {k}_{0} ( n )\end{matrix}$$

The Bayesian estimator for \hat{p}ᵢⱼ(n) only compensates for the difference between the user experience that resulted from the prior value pᵢⱼ(n) of and the desired user experience. The effects of zᵢⱼ(n+1) reflecting information from new playlists, new playstreams and metadata on the PCC dataset must also be incorporated in the computation for the new pᵢⱼ(n+1) value to be used in the PCC dataset until the next update instant. If it is assumed that the difference between the value pᵢⱼ(n+1) used by the recommender until the next update instant and the compensated \hat{p}ᵢⱼ(n) value for the current instant n is solely determined by the playstreams, playlists, and metadata fed into the system between instant n and n+1, an estimate for pᵢ(n+1) can be expressed as:

pᵢⱼ(n+1)=\hat{p}ᵢⱼ(n)+zᵢⱼ(n)−zᵢⱼ(n−1)

Finally, the notation with regard to time instants can be cleaned up a bit by letting pᵢⱼ(n) denote the random variable for the value of pᵢⱼ to be used from time instant n until the next update at time instant n+1, and letting dᵢⱼ(n) denote the random variable for the value of dᵢⱼ based on the user feedback from time instant n−1 until the update at time instant n based on experiences generated by the recommender for the value pᵢⱼ(n−1). With those definitions, the random variable pᵢⱼ(n) can be expressed as:

pᵢⱼ(n)=kₚpᵢⱼ(n−1)+k_{d}dᵢⱼ(n)+k₀(n)+zᵢⱼ(n)−zᵢⱼ(n−1)

It is important to note that even though the assumptions about the forms of the densities fₚ(pᵢⱼ) and f_{p|d}(pᵢⱼ|dᵢⱼ) may not match the actual data, and therefore that the estimate for pᵢⱼ(n) may be sub-optimal, the overall system may be stable as long as the estimates of dᵢ(n) and dᵢⱼ(n) are constrained such that dᵢ(n)≧dᵢⱼ(n). In production, the sub-optimal performance of the adaption process may be all but obscured by the other random effects in the system, but it may be necessary to estimate the relevant distributions if experience shows that better performance is required.

### Second Embodiment of User Feedback System

In another embodiment, consumption of media items by a single user may be organized into sets of items, which in the case of music media items may be called “tracks.” Sets may be referred to as a session [symbol] ={I₁, . . . , Iₗ}.

[symbol] ᵢ(n) may denote the set of sessions for day n which include item i. If user sessions span multiple days, sessions may be arbitrarily divided into multiple sessions. In a particular embodiment users may be restricted from randomly requesting items. However a user may request repeated performances and may skip the first or subsequent repeated performances. As a result, in general the set of sessions including i can be represented as the union [symbol] ᵢ(n)= [symbol] ᵢ(n)∪ [symbol] ᵢ(n) of two non-disjoint subsets [symbol] ᵢ(n) and [symbol] ᵢ(n) which include plays and skips, respectively, of item i.

For the purposes of discussion, the raw PCC dataset for item i are represented as φᵢ, and the final PCC dataset as θᵢ(k), where φ_{i,j}, ≡r_{i,j} and θ_{i,j}(k) are the values for item j in the respective PCC dataset for item i. Xᵢ(k), represents the number of times the system selects item i for presentation to the audience over some interval nₖ−Δ<n≦nₖ. Similarly, for the same time period, Yᵢ(k) represents the number of times the audience would like to have item i performed, and the number of times the audience would like item j performed in a session with item i is represented as y_{i,j}(k).

In one embodiment, inferring θ_{i,j}(k) from φ_{i,j}(k), Xᵢ(k), Yᵢ(k), and y_{i,j}(k) proceeds in two phases at each update instant k. In the first phase, the quantities Xᵢ(k), Yᵢ(k), and y_{i,j}(k) are inferred from the data. Using those statistics, in the second phase the final PCC entry θ_{i,j}(k) is estimated from the values for Xᵢ(k), Yᵢ(k), and y_{i,j}(k) computed in the first phase and φ_{i,j}(k) using simple Bayesian techniques.

### Phase 1

### Processing the Raw User Feedback

In an embodiment in the first phase the number Xᵢ(k) of presentations of item i the system makes to the audience is expressed and the number Yᵢ(k) and y_{i,j}(k) of performances of item i and performances of item j in a session with item i, respectively, the audience preferred is inferred. Xᵢ(k) is based on the system constraints. Since the user may not randomly request an item, and the system does not initiate presentation of an item more than once in an session, the number of presentations by the system is the number of sessions containing at least one play or skip of item i:

$${X}_{i} ( k ) = {\sum }_{n = {n}_{k - 1} - Δ + 1}^{{n}_{k}} \vert {P}_{i} ( n ) ⋃ {S}_{i} ( n ) \vert$$

Although a particular session may include more than one instance of item i, only the first instance in either subset would have been presented by the system to the user. For later use in computing y_{i,j}(k), the analogous number of presentations of item j in a session with item i by the system is:

$${X}_{i , j} ( k ) = {\sum }_{n = {n}_{k - 1} - Δ + 1}^{{a}_{k}} \vert [ {P}_{i} ( n ) ⋃ {S}_{i} ( n ) ] ⋂ [ {P}_{j} ( n ) ⋃ {S}_{j} ( n ) ] \vert$$

In contrast to Xᵢ(k), Yᵢ(k), and y_{i,j}(k) reflect audience responses to the items presented to them. As noted previously, the audience members may have two types of responses available to them. First, they may chose to listen to the item one or more times, or they may skip the item. And they may rate the item as “thumbs up”, “thumbs sideways” or “thumbs down”. Yᵢ(k), and y_{i,j}(k) may be inferred from user feedback provided through these mechanisms by computing certain daily statistics from the session histories described herein below. For convenience, in the description these statistics represent the sum statistic for a daily statistic z(n) as:

$$Z ( n ; Δ ) = {\sum }_{i - n - Δ + 1}^{n} z ( i )$$

The statistics may be assumed to start from day n=1, and therefore z (n;n) is the sum from n=1.

To define Yᵢ(k), three random variables are defined which are daily statistics for the sessions in Pᵢ(n). Let pᵢ(n), sᵢ(n), uᵢ(n), and dᵢ(n) represent the number of plays, skips, “thumbs up” ratings, and “thumbs down” ratings, respectively, for item i. For these daily statistics, define the four sum statistics Pᵢ(n, Δ), Sᵢ(n, Δ), Uᵢ(n,n), and Dᵢ(n, Δ), where Δ defines the time period over which skipped items should be repeated less frequently. Although skipped items are discussed explicitly here, the effect of skips is primarily manifest in the system implicitly through a value for Yᵢ(k) which would be less than the value the system autonomously would present in the absence of skips. The number of plays the audience desired is defined as:

$${Y}_{i} ( k ) = {λ}_{i} [ {X}_{i} ( k ) - {D}_{i} ( {n}_{k} , Δ ) - {S}_{i} ( {n}_{k} , Δ ) ] + {κ}_{i} [ {P}_{i} ( {n}_{k} , Δ ) + {S}_{i} ( {n}_{k} , Δ ) - {X}_{i} ( k ) ] + {η}_{i} {U}_{i} ( {n}_{k} , {n}_{k} ) + {ξ}_{i}$$

The first bracketed term reflects the number of performances of those presented by the system that the audience actually chose to accept. The second bracketed term is the number of repeats requested by the audience, and the third term is a boost factor to reflect the historical popularity of highly-rated items. Assume that rating an item “thumbs down” does not automatically cause the system to skip the item and that a play is registered for the item. If the system automatically skips the item in response to a “thumbs down” user rating the first term would be Xᵢ(k)−Sᵢ(nₖ, Δ).

The weighting factors specify the relative emphasis the system should give to the audience response to the baseline system presentation (λᵢ), audience requested repeats (kᵢ), and ratings (nᵢ). The constant ξᵢ plays a role in the second phase where it in effect prevents the system from exaggerating the similarity between item i and other items a session based on too little data about item i.

The number of performances of item j in a session with item i that the audience desired is defined in an analogous way to Yᵢ(k). First let x_{i,j}(n), p_{i,j}(n), s_{i,j}(n), u_{i,j}(n), and d_{i,j}(n) represent a number of presentations, plays, skips, “thumbs up” ratings, and “thumbs down” ratings, respectively, for item j in a session in which the user accepts a performance of item i, and define the corresponding sum statistics X_{i,j}(k), P_{i,j}(n, Δ), S_{i,j}(n, Δ), U_{i,j}(n, n), and D_{i,j}(n, Δ). The number of performances of item j in a session with item i desired by the audience then is:

$${y}_{i , j} ( k ) = {λ}_{i , j} [ {X}_{i , j} ( k ) - {D}_{i , j} ( {n}_{k} , Δ ) - {S}_{i , j} ( {n}_{k} , Δ ) ] + {κ}_{i , j} [ {P}_{i , j} ( {n}_{k} , Δ ) + {S}_{i , j} ( {n}_{k} , Δ ) - {X}_{i , j} ( k ) ] + {n}_{i , j} {U}_{i , j} ( {n}_{k} , {n}_{k} ) + {ξ}_{i , j}$$

System constraints that preclude the system from presenting an item more than once per session to a user, and the definition of X_{i,j}(k) is:

Xᵢ(k)−Dᵢ(nₖ,Δ)−Sᵢ(nₖ,Δ)≧X_{i,j}(k)≧X_{i,j}(k)−D_{i,j}(nₖ,Δ)−S_{i,j}(nₖ,Δ)

Similarly, since under the same constraints an item can only be rejected at most once per session, Uᵢ(nₖ, nₖ)≧U_{i,j}(nₖ, nₖ). If the user could not request that items be repeated, then Yᵢ(k)≧y_{i,j}(k) if λᵢ≧λ_{i,j}, kᵢ≧k_{i,j}, nᵢ≧n_{i,j}, and ξᵢ≧ξ_{i,j}. However, because the number of repeats a user may request of item i is independent of the number of repeats he or she can request of item j, we cannot assume that:

Pᵢ(nₖ,Δ)+Sᵢ(nₖ,Δ)−Xᵢ(k)≧P_{i,j}(nₖ,Δ)+S_{i,j}(nₖ,Δ)−X_{i,j}(k)

or, therefore, that Yᵢ(k)≧y_{i,j}(k). Since it seems that a specific user request that item j be repeated would typically mean that the user just likes item j, rather than the user prefers joint performances of item i and item j, and repeats will be relatively infrequent, to account for this y_{i,j}(k) by can be arbitrarily upper-bound by Yᵢ(k).

Additionally, the coefficients λᵢ, kᵢ, nᵢ, ξᵢ, and λ_{i,j}, k_{i,j}, n_{i,j}, ξ_{i,j} may be selected using various techniques. One approach would be to derive the coefficients such that Yᵢ(k) and □_{□,□}(k) are a maximum likelihood or Bayesian estimates based on the observed data Pᵢ(n, Δ), Sᵢ(n, Δ), Uᵢ(n, n), Dᵢ(n, Δ), and P_{i,j}(n, Δ), S_{i,j}(n, Δ), U_{i,j}(n, n), and D_{i,j}(n, Δ).

Another method is the ad hoc technique based on the “gut feeling” how each component should be weighted to give the best picture of the audience preferences. In this case, it is important first to understand the role of the constant terms ξᵢ and ξ_{i,j} by examining the ratio x_{i,j}|Xᵢ. As Xᵢ becomes small, this ratio becomes increasingly non-representative of the entire audience. One way to counter this is to choose ξᵢ and ξ_{i,j} such that the ratio ξᵢ/ξ_{i,j} reflects the similarity value φ_{i,j} for item j in the PCC dataset for item i. The Bayesian estimation technique outlined in the below presents one formal alternative for incorporating φ_{i,j}.

Another important observation for the ad hoc approach is that the coefficients kᵢ and kᵢⱼ, determine how much repeat requests by the audience members should be weighted. Arguably m repeat requests by a single audience member should be given less emphasis than m repeat requests by m audience members so kᵢ and kᵢⱼ, should be monotonic increasing functions of the number of audience members represented by the sessions in [symbol] ᵢ, [symbol] _{i,j}. The same reasoning applies to the coefficients ηᵢ and η_{i,j} on the contribution of the positive rated items.

### Phase 2

### A Bayesian Approach to Determining the Final PCC

Once the random process models Xᵢ(k), Yᵢ(k), and y_{i,j}(k) for the audience preference statistics are derived, a parameter estimation problem arises which is: For each pair of items i and j, there are observations y_{i,j}(k) described by a random process y_{i,j}(k) whose sample instants have the distribution f_{y}(y) that depends in some way on the element θ_{i,j} in the final PCC dataset. There is also prior information in the form of an entry φ_{i,j} in the raw PCC dataset. In order to find the value of the parameter θ_{i,j} that best explains the observations y_{i,j}(k) given the prior information φ_{i,j}, and to develop a realistic way for computing the weighting coefficients α, β, and γ an estimator of the general form:

θ(k)=αφ+βy(k)+γ

is used.

Thus, at any particular time assume that entry θ_{i,j} for item j in the PCC dataset for item i is the probability that item j should be presented to a user in a session with track i. Under this assumption, y_{i,j}(k) has a binomial distribution (again omitting the subscripts to clarify the notation):

$${f}_{y} ( y ) = ( \begin{matrix}Y \\ y\end{matrix} ) {{θ}^{y} ( 1 - θ )}^{Y - y}$$

where, for a particular y_{i,j}(k), θ_{i,j}(k), is an element of the final PCC dataset. Yi(k)=Yi(k) is the maximum number of possible presentations of item j in the context of item i derived by the methods discussed above in Phase 1, and is independent of the number of presentations of j.

Two approaches for estimating \hat{θ}_{i,j}(k) that provides an explanation for an observed value y′_{i,j}(k)=min {y_{i,j}(k),Yᵢ(k)}=y_{i,j}(k) where the observed value y′_{i,j}(k) is taken to be bounded by Yᵢ(k) to account for possible user-requested repeats of item j in a session with item i are discussed herein. First, a maximum likelihood estimate for the second embodiment of the user feedback system in the absence of any other information about θ_{i,j}(k) and y_{i,j}(k) is discussed. Then a Bayesian estimator for the second embodiment of the user feedback system which incorporates additional knowledge of the prior PCC φ_{i,j}(k) used to determine the number of items x_{i,j}(k) originally presented to the user is discussed.

### The Maximum Likelihood Estimator

### Second Embodiment of User Feedback System

In the absence of any other information except the observed data y_{i,j}(k)=y_{i,j}(k), a choice for θ_{i,j} would be the maximum likelihood estimate (MLE) \hat{θ}ᵢⱼ. Omitting subscripts for notational clarity, the MLE \hat{θ} is the value of θ for which:

$$\begin{matrix}0 = \frac{\partial {f}_{y} ( y )}{\partial θ} {\vert}_{\hat{θ}} \\ = ( \begin{matrix}Y \\ y\end{matrix} ) [ y {{\hat{θ}}^{y - 1} ( 1 - \hat{θ} )}^{Y - y} - ( Y - y ) {{\hat{θ}}^{y} ( 1 - θ )}^{Y - y - 1} ] \\ = y - Y \hat{θ}\end{matrix}$$

showing, in the absence of any additional information about θᵢⱼ(k), the best estimate is \hat{θ}_{i,j}(k)=y_{i,j}(k)/Yᵢ(k).

### Bayes Estimation

### For the Second Embodiment

The naive maximum likelihood estimator makes no assumptions about the properties of θ_{i,j}(k). The Bayesian approach to estimation assumes instead that θ_{i,j}(k) is a random variable θ_{i,j}(k) whose prior distribution f_{θ}(θ) is known at the outset and treats the distribution f_{y|θ}(y;θ) of the observed data as a conditional distribution f_{y|θ}(y|θ). In this case of interest is an estimate \hat{θ}_{i,j}(k) given the observation y_{i,j}(k) and the assumption for the prior distribution of θ_{i,j}(k).

In the Bayesian estimation framework, \hat{θ}_{i,j}(k) is referred to as an a posteriori estimate for θ_{i,j}(k), and is the value of θ for which the posterior distribution:

$${f}_{θ \vert y} ( θ \vert y ) = \frac{{f}_{y , θ} ( y , θ )}{{f}_{y} ( y )} = \frac{{f}_{y \vert θ} ( y \vert θ ) {f}_{θ} ( θ )}{{f}_{y} ( y )}$$

has minimum variance. This minimum variance Bayes estimate is the conditional mean θ_{i,j}(k)=E{θ|y} of f_{θ|y}(θ|y).

The conditional distribution f_{θ|y}(θ|Y) is assumed to be binomial. Further, f_{θ}(θ) is assumed to be the conjugate prior density of f_{θ|y}(θ|y). For a binomial conditional, the conjugate prior is the beta density:

$${f}_{θ} ( θ ) = ( X φ + 1 ) ( \begin{matrix}X \\ X φ\end{matrix} ) {{θ}^{X φ} ( 1 - θ )}^{X - X φ}$$

where φ_{i,j} is an element of the initial PCC dataset used to select the x_{i,j}(k) and Xᵢ(k)=Xᵢ(k) is the actual number presentations of item i initiated by the system derived by the methods of the previous section. Use Xᵢ(k) φ here rather than x_{i,j}(k) to explicitly incorporate the nominal influence of φ into the model rather than implicitly introduce φ via its influence on the observations x_{i,j}(k).

Given the conditional distribution f_{θ|y}(θ|y) and the prior density f_{θ}(θ), joint density can be directly expressed as:

$$\begin{matrix}{f}_{y , θ} ( y , θ ) = {f}_{y \vert θ} ( y \vert θ ) {f}_{θ} ( θ ) \\ = ( X φ + 1 ) ( \begin{matrix}X \\ X φ\end{matrix} ) ( \begin{matrix}Y \\ y\end{matrix} ) {{θ}^{X φ + y} ( 1 - θ )}^{( X + Y ) - ( X φ + y )}\end{matrix}$$

From the joint density, the marginal distribution can be derived as:

$$\begin{matrix}{f}_{y} ( y ) = {\int }_{0}^{1} {f}_{y , θ} ( y , θ ) d θ \\ = ( X φ ) + 1 ( \begin{matrix}X \\ X φ\end{matrix} ) ( \begin{matrix}Y \\ y\end{matrix} ) {( X + Y + 1 )}^{- 1} {( \begin{matrix}X + Y \\ X φ + y\end{matrix} )}^{- 1}\end{matrix}$$

Taking the quotient shows that the posterior density is also a beta density:

$${f}_{θ \vert y} ( θ \vert y ) = ( X + Y + 1 ) ( \begin{matrix}X + Y \\ X φ + y\end{matrix} ) {{θ}^{X φ + y} ( 1 - θ )}^{( X + Y ) - ( X φ + y )}$$

Thus, from the posterior density f_{θ|y}(θ|y) the Bayes estimator is:

$${\hat{θ}}_{M S E} = E \{ θ \vert y \} = \frac{X}{X + Y + 2} φ + \frac{1}{X + Y + 2} y + \frac{1}{X + Y + 2}$$

For comparison, the maximum likelihood estimator is the value \hat{θ}_{MSE} for which f_{θ|y}(θ|y) assumes a maximum value (the mode). Using the methods of Phase 1, the following estimate is found:

$${\hat{θ}}_{ML} = \frac{X}{X + Y} φ + \frac{1}{X + Y} y$$

The weighted sum forms of these estimates highlights how the coefficients depend on the sizes of the data sets in contrast to weighted sum formulations with fixed coefficients, and how both estimates can differ significantly from the maximum likelihood estimate of the previous section where the initial PCC value φ_{i,j} is not taken into account. This form also shows how the Bayes estimate includes a constant term that is not present in the ML estimate. Finally, for small X+Y the difference between the two estimates can be non-trivial, but for either large X or large Y the two estimates converge:

$$\begin{matrix}{lim}_{X \to ∞} ( {\hat{θ}}_{ML} - {\hat{θ}}_{M S E} ) = {lim}_{m \to ∞} ( {\hat{θ}}_{ML} - {\hat{θ}}_{M S E} ) \\ = {lim}_{m \to ∞} \frac{2 X}{( X + Y + 2 ) ( X + Y )} φ + \\ \frac{2}{( X + Y + 2 ) ( X + Y )} y - \frac{1}{( X + Y + 2 )} \\ = 0\end{matrix}$$

### Differentiating Negative from Null Audience Feedback

Although every item in every PCC dataset could be updated at each time instant, however for the case Yᵢ(k)=0 and therefore y_{i,j}(k)=0, in this case set:

$${\hat{θ}}_{M S E} = E \{ θ \vert y \} {\vert}_{Y = 0 , y = 0} = \frac{X}{X + 2} φ + \frac{1}{X + 2}$$

Thus, even though the audience did not desire any performances of item i, or item j in the presence of item i, the value of θ_{i,j}(k) differs from φ_{i,j}. Note this is not the case for the maximum likelihood estimator since:

$${\hat{θ}}_{ML} = \frac{X}{X + 0} φ + \frac{1}{X + 0} 0 = φ$$

To differentiate the case of null audience feedback (no presentations of an item), from wholly negative audience feedback (all skips) can be done by elaborating the actual process for the estimator as follows:

$${θ}_{i , j} ( k ) = \{ \begin{matrix}{\hat{θ}}_{M S E ( i , j )} ( k ) & If {X}_{i} ( k ) > 0 \\ {θ}_{i , j} ( k - 1 ) & If {X}_{i} ( k ) = 0\end{matrix}$$

where θ_{i,j}(0)=φ_{i,j}.

The proposed process for building PCC datasets seeks to combine processes for building U(n) and L(n) to build PCCs for the recommender. The new process suggests it can be reasonably viewed as a dynamical system driven by statistical data about user consumption, catalog metadata, and user feedback in response to recommender performance. The data processing involved has been described at a certain level of abstraction to provide reasonable insight into the actual objective of each step without prescribing specific, possibly suboptimal, computations in needless detail. The resulting system merges the two independent processes into a single process that addresses the cold start problem in reasonably simple but useful way. Finally, the new process provides a method for fine-tuning the PCCs in response to user feedback.

It will be obvious to those having skill in the art that many changes may be made to the details of the above-described embodiments without departing from the underlying principles of the invention. The scope of the present invention should, therefore, be determined only by the following claims.

1. A computer implemented method for incorporating media item data for use in a media item recommender system, the method comprising:
accessing a first database comprising a plurality of media item identifiers and associated metadata corresponding to each of a plurality of media items identified by the media item identifiers;
generating first correlation data based on a comparison of the metadata corresponding to pairs of the media item identifiers to detect similarities between the media items identified;
accessing a second database comprising a plurality of media item identifier sets for identifying sets of media items;
generating second correlation data based on an analysis of the media item identifier sets to determine incidence of selected subsets of media item identifiers occurring together in a same media item identifier set;
accessing a third database comprising a plurality of consumed media item identifier sets, wherein the consumed media item identifier sets comprise associated one or more media item identifiers corresponding to media item consumption data;
generating third correlation data based on an analysis of the consumed media item identifier sets to determine incidence of selected subsets of the consumed media item identifiers occurring together in a same consumed media item identifier set; and
merging the first, second, and third correlation data to generate media item recommender data.

2. The computer implemented method according to claim 1 further comprising:
generating media item recommendations for user consumption during a user session based on the media item recommender data, wherein the user session includes presentation of at least one pair of media items;
accessing user session data, wherein the user session data corresponds to user feedback characterizing user reactions to the presentation of recommended media items;
analyzing the user session data for an individual media item of the pair and for the pair of media items to form user feedback statistics; and
modifying the media item recommender data based on the user feedback statistics to generate tuned media item recommender data.

3. The computer implemented method according to claim 2, wherein the user session data comprises data reflecting a plurality of media sessions among a defined audience of users.

4. The computer implemented method according to claim 1, further comprising decreasing a contribution of the first correlation data to the media item recommender data over a time period relative to the contribution of second and third correlation data to the media item recommender data.

5. The computer implemented method according to claim 1, wherein merging the first, second, and third correlation data further comprises:
combining the second and third correlation data together to generate a preliminary recommender dataset; and
adding the preliminary recommender dataset together with the first correlation data to generate the media item recommender data.

6. The computer implemented method according to claim 5, wherein combining the second and third correlation data together further comprises:
estimating a probability of association for pairs of media items identified in the second and third correlation data to generate an association dataset based on similarity; and
generating the preliminary recommender dataset based on relationships between the media items in the association dataset.

7. The computer implemented method according to claim 6, further comprising a graph search of the first association dataset comprising:
generating a first graph corresponding to the first association dataset comprising first nodes and first edges, wherein each node represents a media item and each edge represents the second or third correlation data, or combinations thereof;
searching the first graph to identify and characterize paths between connected nodes; and
generating a second graph comprising second nodes associated with the first nodes and further comprising second weighted edges connecting pairs of second nodes wherein the second weighted edges correspond to the paths identified in the first graph.

8. The computer implemented method according to claim 7, wherein the second weighted edges correspond to similarity or distance, or combinations thereof between the media items connected by the second weighted edges.

9. The computer implemented method according to claim 8, further comprising generating a third graph comprising third nodes and third weighted edges,
wherein the third nodes correspond to the plurality of media items,
wherein every third node is connected to every other third node in the third graph, and wherein the third weighted edges correspond to the similarity between the connected third nodes based on the first correlation data.

10. The computer implemented method according to claim 9, wherein merging the first, second, and third correlation data to generate media item recommender data further comprises combining the second and third graphs.

11. The computer implemented method according to claim 6, wherein if there are media item identifiers in the first database that do not appear in the second or third databases then combining the preliminary recommender dataset with the third correlation data.

12. The computer implemented method according to claim 2, wherein the user feedback corresponds to media item plays, skips, repeats, negative user evaluation, neutral user evaluation, or positive user evaluation, or combinations thereof.

13. The computer implemented method according to claim 2, wherein analyzing of the user session data to form user feedback statistics occurs at predetermined time intervals.

14. The method according to claim 2, wherein modifying the media item recommender data based on the user feedback statistics further comprises:
generating a first graph comprising a first plurality of media item identifiers connected at least in pairs via first edges, the first edges corresponding to the second and third correlation data;
generating a second graph comprising the first plurality of media item identifiers connected via second weighted edges, the second weighted edges connecting all pairs of media items identifiers for which a connecting path exists in the first graph, wherein the second weighted edges correspond to a similarity metric between media items based on the first graph;
generating a third graph comprising a second plurality of media item identifiers comprising at least one media item identifier not present in the first plurality of media item identifiers, wherein pairs of media item identifiers are connected via third weighted edges, wherein the third weighted edges correspond to the similarity between the connected media items based on the first correlation data;
generating a fourth graph comprising a third plurality of media item identifiers connected via fourth weighted edges, wherein the fourth weighted edges correspond to the similarity between the connected media items based on the user feedback statistics;
combining the first, second, third, and fourth graphs to generate the tuned media item recommender data.

15. The computer implemented method according to claim 2, wherein modifying the media item recommender data based on the user feedback statistics further comprises:
generating a first data structure representing co-occurrence estimation data corresponding to the second and third correlation data;
generating a second data structure representing similarity data based on the co-occurrence data of the first data structure;
generating a third data structure representing similarity data corresponding to the first correlation data;
generating a fourth data structure representing similarity data corresponding to the feedback statistics;
combining the first, second, third, and fourth data structures to generate the generate tuned media item recommender data.

16. The computer implemented method of claim 1, further comprising generating the database of consumed media item identifier sets by segmenting media items played by users according to predetermined segmenting criteria and storing media items played during a same segment as a single consumed media item set.

17. The computer implemented method of claim 16, wherein the predetermined segmenting criteria comprises a change in two or more of the following: client identification, originating IP address for a play event, offset from GMT for client local time, the two-letter ISO country code returned by GeoIP for the IP address, media play shuffle mode flag, source of play event track, text name of particular source of play event, or name of playlist retuned by music player.

18. A computer implemented method for incorporating media item data for use in a media item recommender system, the method comprising:
accessing a catalog of media item identifiers and associated metadata;
analyzing the metadata to form first association data correlating at least a some of the media items in the catalog;
accessing a catalog of media item identifier sets;
analyzing the media item identifier sets to form second association data corresponding to subsets of media item identifiers occurring in the media item identifier sets;
accessing a catalog of consumed media item identifier sets, wherein the consumed media item identifier sets are grouped based on media consumption data;
analyzing the consumed media item identifier sets to form third association data corresponding to subsets of media item identifiers occurring in the consumed media item identifier sets; and
merging the first, second, and third association data to generate media item identifier recommender data.

19. The computer implemented method for incorporating user feedback according to claim 18 further comprising:
accessing user session data, wherein the user session data is based on user feedback characterizing user reactions to a presentation of recommended media items;
analyzing the user session data to quantify user feedback data for an individual media item of a pair of media items presented during the user session and for the pair of media items to form user feedback statistics; and
modifying the media item recommender data based on the user feedback statistics to generate tuned media item recommender data.

20. The computer implemented method according to claim 18, wherein a contribution of first association data decreases over a time period as a contribution of second and third association data increases over the time period.

21. A system for driving a recommender datastore-based application program, comprising:
a playlist datastore storing a dataset of playlists of media items;
a playstream datastore storing a dataset of playstreams of media items, reflecting user interactions with media items;
a metadata datastore storing a dataset of media catalogs comprising metadata of media items;
a user feedback datastore storing user feedback data generated in response to user interaction events corresponding to presentation of media items to users via the application program;
a processor arranged for combining the playlist dataset, the playstream dataset, the metadata dataset and the user feedback data to form a new dataset of media items; and
a recommender datastore for storing the new dataset and providing access for the application to access the new dataset.
